(19) United States
(12) Patent Application Publication
(10) Pub. No.: US 2026/0244972 A1
(43) Pub. Date: Aug. 20, 2026

(54) METHODS AND SYSTEMS FOR IMPLEMENTING SHOR'S ALGORITHM WITH QUDIT RECYCLING

(71) Applicant: INSTITUT NATIONAL DE LA RECHERCHE SCIENTIFIQUE, QUÉBEC (CA)

(72) Inventors: JINWON YOO, BOUCHERVILLE (CA); NICOLA MONTAUT, SAINT-LAMBERT (CA); STEFANIA SCIARA, SAINT-AMABLE (CA); YOANN JESTIN, MONTRÉAL (CA); ROBERTO MORANDOTTI, MONTRÉAL (CA)

(21) Appl. No.: 19/541,970

(22) Filed: Feb. 17, 2026

Related U.S. Application Data
(60) Provisional application No. 63/759,620, filed on Feb. 18, 2025.

(51) Int. Cl. G06N 10/60; G06N 10/20; G06N 10/40

(52) U.S. Cl. CPC G06N 10/60; G06N 10/20; G06N 10/40

(57) ABSTRACT

Quantum computing harnesses harness quantum mechanics to solve a range of problems extending beyond the capabilities of electronic computers. Quantum computing exploits superposition, entanglement, coherence and interference where quantum processors combine qubits to store information and perform algorithms to yield computational outcomes. One such algorithm is Shor's algorithm which enables superpolynomial speedup in factoring large integers as it can explore multiple potential solutions simultaneously rather than sequentially. However, Shor's algorithm requires the substantial computational resources, qubits, to achieve optimal precision in determining factorization solutions, even for relatively small numbers. To address an approach is presented exploiting higher-dimensional quantum units (qudits) with optimization of the dimensionality of qudits to minimize the number of recycling steps in the iterative Shor's algorithm allowing smaller circuit depths, thereby reducing circuit complexity with deterministic entangling operations to enhance circuit efficiency by utilizing two distinct photonic degrees of freedom.

### CROSS-REFERENCE TO RELATED APPLICATIONS

This patent claims the benefit of priority to U.S. Provisional Patent Application 63/759,620 filed Feb. 18, 2025; the entire contents of which are incorporated herein by reference.

### FIELD OF THE INVENTION

This invention is directed to quantum computing and quantum photonics, more particular to quantum photonic implementations of quantum processing algorithms using higher-dimensional quantum units (qudits), and more particularly to quantum photonic implementations of Shor's algorithm with qudit recycling.

### BACKGROUND OF THE INVENTION

Quantum computing is an emergent field of computer science that seeks to harness the unique qualities of quantum mechanics to solve a range of problems, extending beyond the capabilities of the most powerful classical computers today. Quantum computing exploits four key principles of quantum mechanics, namely superposition (where a quantum particle or system exists not just in one state, but as a combination of multiple possible states), entanglement (whereby multiple quantum particles exhibit correlations that cannot be explained by classical mechanics), coherence (wherein quantum particles maintain phase relationships, allowing them to exhibit superposition and interference effects), and interference (wherein quantum states can interact and produce more and less likely probabilities).

Whilst conventional electronics relies on digital bits (zero and one) to store and process data, quantum computers can encode even more data at once using superposition states known as quantum bits or qubits (two-dimensional quantum information units). Whilst these can behave like a bit and store either a zero or a one, they can also be a weighted combination of zero and one at the same time. When combined, qubits in superposition can scale exponentially such that two qubits can compute with four pieces (digital bits) of information, three with eight pieces, four with sixteen etc. However, each qubit can only output a single bit at the end of the computation process although the underlying quantum algorithms within quantum computing work by storing and manipulating information inaccessible to digital electronics. Accordingly, as with microprocessors in digital electronics, quantum processors require a combination of qubits to store information and perform algorithms to yield computational outcomes.

For example, Shor's algorithm (see Shor, “Algorithms for quantum computation: discrete logarithms and factoring”, Proc. 35^{th} Symp. Foundations of Computer Science, 1994) enables a superpolynomial speedup in factoring large integers compared to classical methods as it exploits quantum mechanics to explore multiple potential solutions simultaneously rather than sequentially with conventional digital electronics. However, the algorithm's approach has broader implications beyond integer factorization as it lays the groundwork for addressing combinatorial optimization problems (see for example Pirnay et al., “An in-principle super-polynomial quantum advantage for approximating combinatorial optimization problems via computational learning theory”, Sci. Adv., 10(11), 2024) where the goal is to find an optimal solution from a finite set of possibilities. Applying the principles of Shor's algorithm, quantum computing can be used to solve a variety of complex optimization scenarios, such as finding the most efficient supply chain, the cheapest delivery route, and the fastest three-dimensional print, offering significant efficiency improvements over classical approaches.

However, a major challenge in executing Shor's algorithm is the substantial computational resources, qubits, needed to achieve optimal precision in determining factorization solutions, even for relatively small numbers. Accordingly, prior art techniques such as qubit recycling have been established but the computational demands of implementing Shor's algorithm remain challenging.

Accordingly, the inventors have established an approach that exploits quantum photonics to address prior implementation limitations by employing higher-dimensional quantum units, or qudits, which have greater computational capacity compared to qubits (thereby reducing the number of qudits required for processing and consequently, decreasing the computational complexity); optimizing the dimensionality of qudits to minimize the number of recycling steps in the iterative Shor's algorithm (leading to smaller circuit depths, thus a further reduction in circuit complexity); and implementing deterministic entangling operations to enhance circuit efficiency with single-photon quantum states by utilizing two distinct photonic degrees of freedom.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to quantum computing and quantum photonics, more particular to quantum photonic implementations of quantum processing algorithms using higher-dimensional quantum units (qudits), and more particularly to quantum photonic implementations of Shor's algorithm with qudit recycling.

In accordance with an embodiment of the invention there is provided a method comprising:
encoding a first d-level qudit with a first register associated with a quantum algorithm within a first degree of freedom of a photon;
encoding a second d-level qudit with a second register associated with the quantum algorithm within a second degree of freedom of the photon; and
executing a quantum algorithm which is executed in a two or more step process and employs a deterministic two-d-level qudit entangling gate operation with the first d-level qudit and second d-level qudit where the second d-level qudit is recycled between sequential steps of the process.

In accordance with an embodiment of the invention there is provided a method comprising:
applying simultaneous qudit encoding in both frequency and time domains of freedom of a single photon; and
executing a quantum algorithm with the simultaneously encoded single photon which includes a deterministic two-qudit entangling gate operation.

In accordance with an embodiment of the invention there is provided a photonic quantum computing system wherein the photonic quantum computing system applies simultaneous qudit encoding in both frequency and time domains of freedom to a single photon.

In accordance with an embodiment of the invention there is provided a photonic quantum computing system, wherein
the photonic quantum computing system applies simultaneous qudit encoding in both frequency and time domains of freedom to a single photon; and
the photonic quantum computing system executes a quantum algorithm comprising at least a deterministic two-qudit entangling gate operation performed with the simultaneously encoded single photon.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A and 1B schematically depict the original Shor's algorithm and process respectively;

FIG. 2 schematically depicts Shor's algorithm process with recycling;

FIG. 3 schematically depicts a quantum computation circuit for implementing Shor's algorithm with recycling;

FIG. 4 depicts a qudit-based iterative Shor's algorithm circuit according to an embodiment of the invention;

FIG. 5 depicts a schematic of a photonic implementation of a circuit for a qudit-based iterative Shor's algorithm circuit according to an embodiment of the invention;

FIG. 6 depicts the measured probability distribution of N=15 factorization with all possible random integers employing the photonic circuit depicted in FIG. 5;

FIG. 7 depicts probability distribution results for N=51 factorization using a compiled Shor's algorithm approach according to an embodiment of the invention;

FIG. 8 depicts the probability distribution of the target register states, conditioned by a control register state, for N=15 factorization using an iterative Shor's algorithm approach according to an embodiment of the invention;

FIG. 9 depicts the probability distribution of the target register states, conditioned by a control register state, for N=51 factorization using a compiled iterative Shor's algorithm approach according to an embodiment of the invention;

FIG. 10 depicts a simulation of the period finding process for factoring N=51 using a compiled Shor's algorithm approach according to an embodiment of the invention; and

FIG. 11 depicts photonic circuit architectures for photonic implementation of higher-order qudits within an implementation of Shor's algorithm for factoring larger integers.

### DETAILED DESCRIPTION

The present invention is directed to quantum computing and quantum photonics, more particular to quantum photonic implementations of quantum processing algorithms using higher-dimensional quantum units (qudits), and more particularly to quantum photonic implementations of Shor's algorithm with qudit recycling.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the invention. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which guides the optical signals vertically relative to a substrate upon which the 2D waveguide is formed but does not guide the optical signals laterally relative to the propagation direction of the optical signals within the 2D waveguide.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals vertically relative to the substrate upon which the 3D waveguide is formed as well as laterally relative to the propagation direction of the optical signals within the 3D waveguide.

A “photonic integrated circuit” (PIC) as used herein may refer to, but is not limited to, the monolithic integration of multiple integrated optics devices into a circuit formed upon a common substrate providing an optical routing and processing functionality comprising one or more optical waveguides, such as 2D waveguides and 3D waveguides for example. The PIC is fabricated using processing techniques at a wafer level, e.g. CMOS manufacturing flows, MEMS processing flows, etc. A PIC according to embodiments of the invention may operate upon a telecommunication band or it may operate upon a non-telecommunication band.

A telecommunication band of a PIC may be, for example the “O-band” which refers to, but is not limited to, the wavelength range 1260-1360 nm; the “E-band” which refers to, but is not limited to, the wavelength range 1360-1460 nm; the “C-band” which refers to, but is not limited to, the wavelength range 1530-1565 nm; the “S-band” which refers to, but is not limited to, the wavelength range 1460-1530 nm; the “L-band” which refers to, but is not limited to, the wavelength range 1565-1625 nm; and the “U-band” which refers to, but is not limited to, the wavelength range 1625-1675 nm. A non-telecommunication band may be one compatible with solid state optical sources, photodetectors etc. such the infrared wavelength range around 830 nm-850 or within the visible spectrum such as 633 nm etc.

Within the embodiments of the invention the inventors refer to the term “hybridly integrated.” This may, within some embodiments of the invention, refer to, but not be limited to, the “integration” of an optical element onto a substrate (platform) or another element physically integrated with the optical element to the substrate such that the optical element is retained in position.

Within the embodiments of the invention the inventors refer to the term “monolithically integrated.” This may, within some embodiments of the invention, refer to, but not be limited to, the “integration” of optical elements onto or within a substrate directly forming each optical component onto or within the substrate. The manufacturing processes for the optical elements may be concurrent, plesiochronous or asynchronous. Each optical element may be formed from one or more processes selected from the group comprising, but not limited to, LPE, MOCVD, OMVPE, selective area epitaxy, an additive manufacturing process, a non-additive manufacturing process, crystal growth, doping, induced damage, etching, doping and deposition.

An optical element may employ one or more semiconductors grown using LPE, MOCVD, and OMVPE, for example. The one or more semiconductors may be selected from, but not limited to, group III-V semiconductors, group II-VI semiconductors, group IV semiconductors, and group IV-V-VI semiconductors. Examples of group III-V semiconductors may include AlP, AlN, AlGaSb, AlGaAs, AlGaInP, AlGaN, AlGaP, GaSb, GaAsP, GaAs, GaN, GaP, InAlAs, InAlP, InSb, InGaSb, InGaN, GaInAlAs, GaInAlN, GaInAsN, GaInAsP, GaInAs, GaInP, InN, InP, InAs, InAsSb, and AlInN. Examples of group II-VI semiconductors may include ZnSe, HgCdTe, ZnO, ZnS, and CdO. Examples of group IV Semiconductors may include Si, Ge, and strained silicon. A group IV-V-VI semiconductor may be GeSbTe.

Within embodiments of the invention the platform or substrate upon which the integration is performed may be a silicon substrate wherein the one or more optical waveguides upon the platform exploit a silicon nitride core with silicon oxide upper and lower cladding, a SiO₂—Si₃N₄—SiO₂ waveguide structure. Alternatively, the one or more optical waveguides may employ a silicon core with silicon nitride upper and lower claddings. Optionally, the upper cladding may be omitted within other embodiments of the invention.

However, it would be evident that other optical waveguide structures may be employed including, but not limited to, silica-on-silicon, doped (e.g., germanium, Ge) silica core with undoped cladding, silicon oxynitride, polymer-on-silicon, or doped silicon waveguides for example. Additionally, other waveguide structures may be employed including vertical and/or lateral waveguide tapers and forming microball lenses on the ends of the waveguides via laser and/or arc melting of the waveguide tip.

Further, whilst embodiments of the invention are described with respect to silicon-on-insulator (SOI) waveguides by way of example, e.g. SiO₂—Si₃N₄—SiO₂; SiO₂—Ge:SiO₂—SiO₂; or Si—SiO₂; it would be evident that within other embodiments of the invention may be employed to coupled passive waveguides to active semiconductor waveguides, such as indium phosphide (InP) or gallium arsenide (GaAs), e.g. a semiconductor optical amplifier (SOA), laser diode, etc. Optionally, an active semiconductor structure may be epitaxially grown onto a silicon IO-MEMS structure, epitaxially lifted off from a wafer and bonded to a silicon integrated optical microelectromechanical systems (IO-MEMS) structure, etc.

However, within other embodiments of the invention a variety of waveguide coupling structures coupling onto and/or from waveguides employing material systems that include, but not limited to, SiO₂—Si₃N₄—SiO₂; SiO₂—Ge:SiO₂—SiO₂; Si—SiO₂; ion exchanged glass, ion implanted glass, polymeric waveguides, InGaAsP, GaAs, III-V materials, II-VI materials, ferroelectric materials such as lithium niobate, and optical fiber. Whilst primarily waveguide-waveguide systems have been described it would be evident to one skilled in the art that embodiments of the invention may be employed in aligning intermediate coupling optics, e.g., ball lenses, spherical lenses, graded refractive index (GRIN) lenses, etc. for free-space coupling into and/or from a waveguide device.

As outlined above Shor's algorithm revolutionized quantum computing by demonstrating a superpolynomial speedup in factoring large integers compared to classical methods by exploiting quantum principles such as superposition and entanglement, to efficiently explore multiple potential solutions simultaneously. However, a major challenge in executing Shor's algorithm is the substantial computational resources, qubits, required to achieve optimal precision in determining factorization solutions, even for relatively small numbers. For factoring the smallest non-trivial number, 15, this requires the preparation, manipulation, and measurement of at least twelve qubits. This presents several challenges as all required qubit states must be generated simultaneously, numerous quantum computational gates are needed to process various combinations of qubits, thereby increasing circuit complexity, and the probabilistic nature of quantum gate operations drastically reduces circuit efficiency (see below for a description of the original version of Shor's algorithm). To overcome these challenges, a more practical approach, the iterative Shor's algorithm, was introduced exploiting qubit recycling. This approach reduces circuit complexity by breaking the computation task into smaller, more manageable processing steps that require fewer qubits. However, this comes at the expense of longer computation times as the process employs a number of iterative steps. In principle, the recycling approach reduces the resource requirement to just five qubits, but it still necessitates eight recycling steps for the optimal factoring of the number 15 (this iterative Shor's algorithm based on recycling technique is described below).

Despite the simplification offered by qubit recycling, meeting the computational demands for Shor's algorithm implementation still remains challenging due to the complexity of managing multiple qubit processing steps, which are highly sensitive to the limited coherence time of quantum states. For instance, factoring the number 15 requires performing tens or even hundreds of precise entangling gate operations, resulting in deep and complex circuits that are vulnerable to instability. As qubits are routed through these large circuits, their coherence diminishes, which compromises the accuracy of the entangling operations and leads to erroneous factorization results.

To mitigate the coherence problem, prior art approaches further simplified Shor's algorithm implementation by incorporating prior knowledge of the factorization outcomes. This approach reduces the number of computational steps, resulting in a suboptimal factoring method known as a “compiled” scheme. While these compiled methods streamline the process, they fall short of delivering the full accuracy and precision that the original Shor's algorithm promises. For instance, a compiled approach demonstrated by Monz (see for example “Realization of a scalable Shor algorithm” (Science 351, pp. 1068-1070, 2016)) utilized the necessary five qubits but reduced the number of recycling steps from eight to three, thereby achieving only a 3-qubit precision in the factorization process instead of the full 8-qubit precision. Despite significant simplification to the computation circuitry, the procedure still demanded over 70 complex qubit entangling operations, making it impractical for realistic computational architectures.

Accordingly, the inventors have addressed the limitations within the prior art by implementing a practical and efficient approach to factoring integers using Shor's algorithm without compromises. The inventive method overcomes the challenges in a qubit-based Shor's algorithm by employing higher-dimensional quantum units, qudits, which have greater computational capacity. This reduces the number of qudits required for processing, thereby decreasing computational complexity, compared to qubits. Further, the inventive method optimizes the dimensionality of the qudits to minimize the number of recycling steps in the iterative Shor's algorithm, thereby leading to reduced circuit depths thereby further reducing complexity. Additionally, the inventive method implements deterministic entangling operations to enhance circuit efficiency using two photonic degrees of freedom (DoFs) (see for example Imany in “High-dimensional optical quantum logic in large operational spaces”, npj Quantum Inf. Vol. 5(59), 2019). The inventive approach enables a full implementation of Shor's algorithm in a resource-efficient manner without relying on prior knowledge of factorization solutions. Further details of the invention are provided below.

Over the past two decades, several small integer factorizations have been demonstrated across various quantum computing platforms, including nuclear magnetic resonance systems, superconductors, ion traps, and photonics. Each platform presents unique advantages and challenges. The inventors have focused on photonic implementations, particularly for addressing the resource constraints associated with qubit-based systems, traditionally implemented through these platforms as photonics provides the possibility to easily harness higher-dimensional quantum units which allow for more efficient quantum operations. Accordingly, the inventors note that qudit-based approaches offer significant potential in optimizing quantum algorithms like Shor's, where resource overhead and computational gate complexity are major bottlenecks. The inventive photonic platform described below with respect to embodiments of the invention provides a scalable pathway for efficiently implementing quantum algorithms while mitigating the limitations associated with qubit coherence time and scalability.

The original Shor's algorithm is outlined below factors a number N by using quantum computation to find the period of the modular exponentiation function (MEF), followed by classical post-processing to determine its composite factors. For the period-finding process, the algorithm dictates the use of two computational registers, a control register for storing the period, and a target register for encoding the MEF. In the original form, the algorithm requires h=[2 log_{d} N] quantum units in the control register, where d is the dimensionality of the quantum unit which equals 2 in the case of qubits. The iterative Shor's algorithm uses a recycling technique to reduce the computational unit requirement in the control register to a single quantum information unit, such as a qubit or qudit, with h recycling steps. The computational resources needed for the target register remains the same as the original version, i.e., n=[log_{d} N]. The inventors note the prior methodology employed by Chi (“A programmable qudit-based quantum processor”, Nat. Commun. 13, 1166, 2022), which demonstrated a qudit recycling approach to Shor's algorithm. Chi's methodology employs two ququarts (4-dimensional quantum information units) encoded in the optical path degree of freedom (DoF), one each for the control and target registers. To factor the number 15, this scheme required h=┌2 log₄ 15┐=4 recycling steps, reducing the number of recycling steps, and therefore the computational time, by half compared to prior art qubit-based implementations.

A photonic path DoF is particularly advantageous in photonic systems, as it can be readily integrated into photonic circuit based architectures. However, preparing higher-dimensional states using this DoF introduces significant design challenges as this approach requires cascading multiple optical interferometers which increase the circuit depth (i.e. the number of gate operations) to d/2=2. It would also be evident that the circuit depth using this prior art technique increases the circuit depth in proportion to the dimensionality of the quantum information units of the system.

Factoring the number 15 requires two ququarts in the target register, according to n=[log 415]=2. However, Chi's method employs only one ququart, limiting the ability to represent all possible random integers during the MEF encoding (see Appendix A), constraining the system's ability to explore the full solution space. Furthermore, due to the use of the same DoF in both control and target registers, the MEF encoding process using entangling gates as outlined below was probabilistic, with a success probability of 1/d and a circuit depth of d=4. This probabilistic nature significantly diminishes the computational efficiency of the prior art implementation. As a result, the system could only be recycled three times, which fell short of the four steps required for the case of ququart resources (h=┌2 log₄ 15┐=4).

A critical procedure in the iterative version of Shor's algorithm is decoding the period of the MEF. This is achieved by feed-forwarding the measurement results into subsequent recycling steps via the phase operator as outlined below. Each recycling step enhances the precision of the final outcome, converging towards the desired accuracy. In Chi the measurement process requires additional cascading of interferometers, similar to the state preparation and MEF encoding process. The circuit depth accordingly increases proportionally to d/2=2, adding complexity, as an even larger number of interferometers are required to manage the higher-dimensional quantum states. This scaling in circuit complexity directly impacts the overall resource requirements, with greater precision control necessary to maintain coherence and accuracy in such higher-dimensional spaces.

The prior art procedure described by Chi successfully reduced the computational time for Shor's algorithm using qudit state processing (i.e., requiring fewer recycling steps), but at the cost of increased circuit complexity and circuit depth. The two-qudit entangling gates developed in Chi whilst they enhanced the factorization process to a 6-qubit precision, exceeding the 3-qubit precision of prior art qubit-based systems, still failed to achieve the optimal 8-qubit precision achievable with a full Shor's algorithm which could not be realized due to the probabilistic nature of the entangling gates and the limited coherence of the quantum circuit. In contrast, the inventors have successfully performed the full Shor's algorithm, attaining optimal precision, through deterministic entangling gate operations via simultaneous encoding of two qudits within a single photon as outlined below.

As noted above the prior art solutions such as Chi have a number of significant limitations which include, but are not limited to:
high circuit depth—the overall circuit depth of Shor's algorithm procedure is determined by the number of gates required for the state preparation, MEF encoding, and decoding, estimated at d/2, d, and d/2, respectively, resulting in a total depth of 2d=8;
probabilistic entangling operations where the use of a single DoF, i.e., the optical path, for both computational registers limits the entangling gates to probabilistic operations which reduce the system efficiency and which would be degraded further if the dimensionality of the qudits were scaled;
complex computational circuitry where whilst the optical path DoF can be implemented in within an integrated photonic circuit, preparing higher-dimensional states requires multiple interferometers and tunable on-chip electronics for precise phase control. This complexity hinders the scalability of the scheme;
limited recycling steps as the optimal number of steps is based on the dimensionality of computational units used in the registers, given by h=┌2 log_{d} N┐, i.e., necessitating four recycling steps for factoring 15 using ququarts. However, due to the system's complexity and low efficiency, only three recycling steps were feasible, preventing the achievement of optimal precision.
insufficient computational units in the target register as a full implementation of Shor's algorithm demands n=┌log_{d} N┐ units in the target register, i.e., two ququarts for factoring 15, but prior art demonstrations, such as Chi, due to the difficulty in simultaneously preparing and manipulating multiple computational units, only employed one ququart. This restricted the system's ability to fully encode the MEF using all possible random integers and prevented the complete implementation of Shor's algorithm.

These drawbacks reduce computational precision, necessitating prior knowledge of the factorization outcomes and undermining the general applicability of Shor's algorithm in quantum computing. As a result, there has yet to be a complete demonstration of Shor's algorithm that implements the entire process. The inventors as will be evident from the description below have overcome the limitations of prior art recycling approaches by utilizing two 16-level qudits, encoded within a single photon, to implement Shor's algorithm. Instead of relying on multiple quantum information units, the inventors exploit a frequency-bin qudit (encoded in discrete frequency levels) for the control register and a time-bin qudit (encoded in discrete time slots) for the target register. This higher-dimensional qudit-based design, combined with a recycling technique, reduces the number of recycling steps required, making it convenient to meet the computational requirements. The dimensionality of the qudits was engineered in the experimental prototypes based upon computation time and circuit depth. The required recycling steps are reduced to h=┌2 log₁₆ 15┐=2, cutting the computational time in half compared to Chi and to a quarter of that required for prior art qubit-based approaches. The invention achieves this with minimal circuit depths of two, one, and two for the state preparation, MEF encoding, and decoding steps, respectively. The full computational capacity of the target register means that all possible random numbers can be encoded into the MEF circuit allowing for the full realization of Shor's algorithm. This means that all random integers can be utilized without relying on prior knowledge to find factorization solutions. Additionally, using separate DoFs for the control and target registers enables deterministic encoding of MEF operations, significantly increasing resource efficiency.

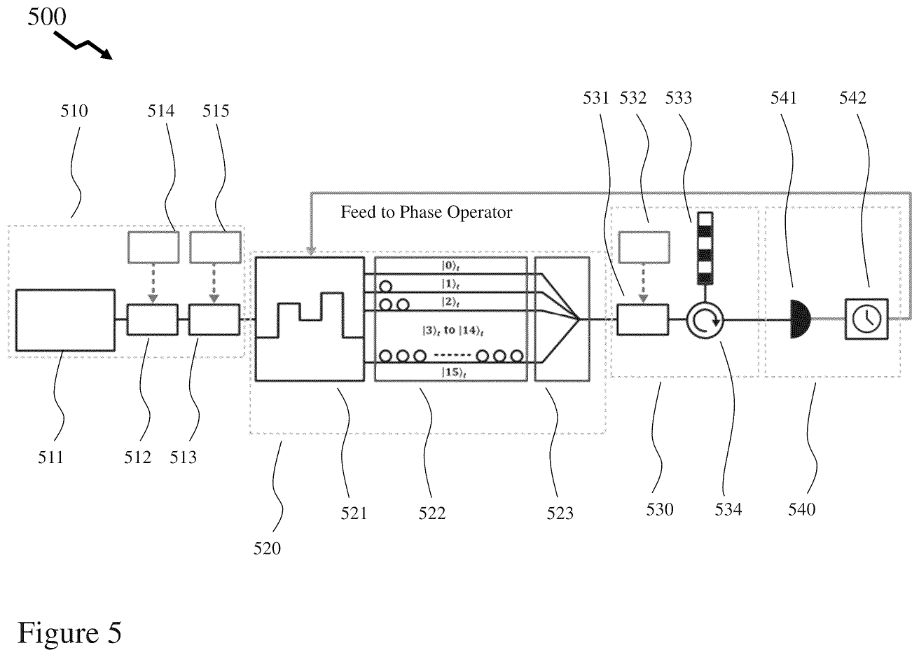

Referring to FIG. 5 a Schematic 500 of an embodiment of the invention is depicted comprising four states, these being:
State Preparation 510;
Modular Exponentiation Function (MEF) Encoding and Phase Operation 520;
Inverse quantum Fourier transform (QFT) 530; and
Measurement 540.

The prototype system depicted in Schematic 500 employs an attenuated continuous wave (CW) Laser 511 operating at ~1550 nm as the single-photon source for preparing the computational registers. The target register is prepared by generating time-bin qudits through an Amplitude Modulator 512, while the control register is created by generating frequency qudits using a first Phase Modulator 513. The Amplitude Modulator 512 and first Phase Modulator 513 being driven from first and second Control Circuits 514 and 515 respectively. Both registers are set to operate in a 16-dimensional state space in the time and frequency domains. The MEF Encoding and Phase Operation 520 is performed using a Programmable Amplitude and Phase Filter (hereinafter ProAP-Fil) 521, which allows for programmable unitary operations at each recycling step by sending each frequency component to the corresponding outputs of the ProAP-Fil 521. These outputs are time-multiplexed through a 16×1 beam Combiner 523 with varying optical delays implemented with Optical Time Delay Block 522. This approach allows for the direct and deterministic implementation of the required unitary operations at each recycling step as outlined below and a circuit depth of one.

The period of the encoded MEF is determined by applying the phase operation followed by the inverse-QFT to the control register. For the first recycling step, the phase parameter is set to zero, while for the subsequent step, the parameter is adjusted based on the previous measurement outcome as outlined below. This phase parameter is applied through the ProAP-Fil 521 to create a low-loss computational circuit. The inverse-QFT is carried out via a second Phase Modulator 531 which receives the output from the MEF Encoding and Phase Operation 520, which performs a frequency mixing operation to yield the computational results. After appropriate spectral filtering using a fiber Bragg grating (FBG) 533, the measurements are performed using a superconducting nanowire single-photon detectors (SNSPD) 541 as outlined below. The optical signals are coupled from the second Phase Modulator 531, which is driven by third Control Circuit 532, to the FBG 533 via a Circulator 534 wherein the reflected signals from the FBG 533 are then coupled to the SNSPD 541. The output of the SNSPD 541 is coupled to a time-correlated single-photon counter (TCSPC) 542 where an output of the TCSPC 542 is coupled back to the ProAP-Fil 521. The measurement outcomes are then processed through classical computation as part of Shor's algorithm, providing the factorization results for the number 15. This method achieves the full 8-qubit precision for the factorization process, a level of accuracy that has not been reached by any prior art implementations to date.

The invention as described and depicted supports factoring various integers N by recycling a frequency qudit ┌2 log_{d} N┐ times for the control register and increasing the dimension of a time qudit for the target register using a ProAP-Fil with N output ports. This is relevant for factoring the number N with any random integer as outlined below. Embodiments of the invention reduce the number of recycling steps by increasing the dimensionality of the frequency qudit, resulting in faster computation than conventional qubit-based approaches. Further, the photonic implementations are also compatible with the use of frequency comb sources, such as ring resonators, which can further increase the dimensionality of the control register. Further, as outlined below the invention supports a fully deterministic inverse-QFT stage by cascading ProAP-Fils 521 and second Phase Modulators 531 with SNSPDs 541, ensuring a fully deterministic scheme. The photonic architecture is compatible with a number of telecom-band and non-telecom band optical sources, including CW lasers, pulsed lasers, and deterministic single-photon sources. The SNSPD 541 can be replaced by any single-photon detection module such as single photon avalanche diodes. Furthermore, the FBG 533 may be replaced with other types of spectral filters, e.g., a wavelength-division multiplexer or another ProAP-Fil.

Whilst the description above and below is focused to a fiber based photonic implementation it would be evident that the photonic implementation may be implemented as a photonic circuit using monolithic and/or hybrid integration to reduce the physical footprint and exploit cost-scale benefits of semiconductor manufacturing technologies. Whilst the description above and below is focused to an optical fiber platform the principles outlined are adaptable to both integrated and free-space quantum photonic platforms, such as those using ring resonators and cavity-based schemes. This versatility ensures that the methodology can be applied across different technologies, potentially improving their computational performance and efficiency in quantum algorithms.

Whilst the description above and below is focused to Shor's algorithm the platform and techniques support programmability to implementation of other quantum computing algorithms that utilize the inverse-QFT and deterministic qudit manipulations, such as the Deutsch-Jozsa algorithm, which can be used to determine whether a given function is constant or balanced, and the Bernstein-Vazirani algorithm, which identifies a hidden affine function, for example. In addition to quantum computing algorithms the concepts described and depicted may be applied to other quantum solutions including, for example, quantum secure communications. The ability to implement the Deutsch-Jozsa algorithm aligns with executing quantum key distribution (QKD) protocols for secure quantum communications which enhance the security of data transmission using quantum encryption methods.

### Qudit-Based Iterative Shor'S Algorithm Overview

As noted above Shor's algorithm, a pivotal quantum factoring method, has faced challenges in implementation due to substantial resource requirements and the complexity of operations involving numerous entangling gates. The use of higher-level quantum units, or qudits, can dramatically reduce these resource demands although the reliance on multiple qubit gates, along with the probabilistic nature of these gates, has prevented previous demonstrations from meeting the algorithm's computational requirements, necessitating prior knowledge of the solution for compilation. The inventors' architecture as described and depicted in respect of FIG. 5 presents a resource-efficient photonic implementation of Shor's algorithm, successfully factoring the number 15 and as outlined below offering a scalable methodology for factoring larger numbers without prior knowledge of the solution in designing the computational process. By utilizing a recycling technique with two 16-level qudits, the inventors effectively prepare 12 qubits, meeting the computational requirements for this factorization, which has not been realized in the prior art. The inventors' methodology leverages a deterministic two-qudit entangling gate operation, enabled via simultaneous qudit encoding in the frequency and time degrees of freedom in a single photon, for achieving efficient and high-fidelity factorization. The inventors outline below the extension to factoring the number 51 using a compiled approach, demonstrating the versatility of the inventive scheme, as an example of extending the concept to higher integers. The architecture presented strengthens photonic quantum computing technologies but also provides a route for advanced implementations of quantum factoring and other non-classical algorithms.

As discussed above Shor's algorithm offers a robust computation framework for factoring large composite numbers, a task beyond the capabilities of classical systems, and whilst renowned for its superpolynomial speedup over classical algorithms its deployment on a quantum computer demands stringent requirements be met (i.e. specifications) which include the implementation of substantial quantum registers to fulfil the dimensionality requirements for computation as well as the optimal processing of quantum units, e.g., qubits, for precise computational operations. For instance, factoring a simple number N=15 necessitates at least 12 qubits, alongside the need for precise qubit control to achieve optimal solutions. To minimize these resource requirements, a semi-classical approach that utilizes qubit recycling has been demonstrated within the prior art, which reduces the number of qubits to 1+┌log₂ N┐ rather than ┌2 log₂ N┐+┌log₂ N┐ required by the original Shor's algorithm. However, this method demands longer processing times, utilizing five qubits and eight recycling steps for N=15 factorization. To date, the maximum recycling steps achieved is three, constrained by the short qubit coherence time necessary to realize precise entangling gate operations, corresponding to a circuit depth (the number of gate sequences)>70. Whilst different approaches have been demonstrated within the prior art that utilize fewer qubits and recycling steps these require leveraging prior knowledge of the factorization results to provide compiled iterative versions of Shor's algorithm.

Higher-level quantum units, or qudits, have been instrumental in the development of prior art implementations of Shor's algorithm, due to their superior information capacity, as well as enhanced computational speed and accuracy. Employing d-level qudits in the iterative approach can, in principle, reduce the required number of quantum units and recycling steps by factors of ┌log₂ N┐−┌log_{d} N┐ and ┌2 log₂ N┐/2┌log_{d} N┐ respectively compared to qubits. The factorization of N=15 within the prior art of Chi was demonstrated using a qudit-based iterative Shor's algorithm with two ququarts (d=4) encoded in the optical path DoF. However, this approach relies on entangling gate operations designed from cascaded qubit gates, resulting in high circuit complexity and a depth scaling with d. Additionally, the probabilistic nature of these entangling gates, with success rates scaling inversely with d, further limits this approach from fully meeting the computational demands of Shor's algorithm. These challenges can be addressed through deterministic two-qudit entangling gates enabled by the use of multiple photonic DoFs. Such deterministic operations have been realized by the simultaneous encoding of frequency and time qudits in a single photon. This approach further reduces circuit depth to unity, thus paving the way towards the realization of complex quantum algorithms, including phase estimation problems.

As outlined within this specification the inventors have demonstrated the factorization of N=15 through an iterative Shor's algorithm scheme by employing 16-level frequency and time qudits encoded in a single photon through commercial fiber- and electro-optic components. The inventive system's dimensionality requirements are met through the judicious recycling of the frequency qudit as well as the use of a single deterministic two-qudit entangling gate.

Shor's algorithm factors an integer N into its prime constituents with a process that involves finding the period r of a modular exponentiation function (MEF) ƒ(x)=a^{x} mod N, where a is a random integer coprime with N and a∈(1, N), satisfying the condition a^{r} mod N=1. The algorithm uses two quantum registers: a control register for storing computational outcomes with precisions that depend on the system's dimensionality, and a target register for encoding the MEF. According to the original Shor's algorithm, the two registers necessitate h=┌2 log_{d} N┐ and n=┌log_{d} N┐ quantum units, respectively, for optimal factoring precision as outlined below. In order to reduce the resource demand, an iterative approach has been employed that is enabled by recycling a single quantum unit in the control register until the dimensionality prerequisite for computation is met. This approach effectively reduces the resource requirement for the control register to h=1, while still requiring n quantum units in the target register. However, this reduction comes at the cost of increased measurement time for obtaining precise computational results.

An effective way to reduce both the total resource requirement and the measurement time is by optimizing the dimensionality of quantum units. For instance, using two 16-level qudits to factor N=15 reduces the number of recycling steps h=┌2 log₂ N┐ to two, which is six steps fewer than a qubit-based iterative approach. As a general rule, qudit-based schemes lower the number of recycling steps by a factor of ┌2 log₂ N┐/┌2 log_{d} N┐ and the quantum resource requirement by ┌log₂ N┐−┌log_{d} N┐ units when compared to traditional systems employing qubits, thus greatly reducing the circuit depth and algorithm complexity.

The concept behind the qudit-based iterative Shor's algorithm is illustrated in FIG. 4. Each recycling step starts with the preparation of the control (ctrl) and target (tar) registers into pure states |0 [symbol] _{ctrl} and |ψₖ [symbol] ₜₐᵣ, respectively, where k=1, 2, . . . , h represents the recycling step. The initial state of the target register is set to |ψ₁ [symbol] ₜₐᵣ=|1 [symbol] ₜₐᵣ in decimal representation. A d-level quantum Fourier transform (QFT) (see Equation (1)) is applied to the control register state, where zₖ and xₖ are the initial and final states of the QFT operation, respectively. The resultant output state is thus given by Equation (2).

$${\hat{F}}_{d} = \frac{1}{\sqrt{d}} {\sum }_{{x}_{k} = 0}^{d - 1} {e}^{2 π i {x}_{k} {z}_{k} / d} \vert {x}_{k} 〉 〈 {z}_{k} \vert \qquad ( 1 )$$

$${{ \frac{1}{\sqrt{d}} {\sum }_{{x}_{k} = 0}^{d - 1} \vert {x}_{k} 〉}_{c t r l} \vert {ψ}_{k} 〉}_{t a r} \qquad ( 2 )$$

The quantum circuit for MEF encoding is derived by decomposing the MEF into h controlled unitary operators

$${\hat{U}}_{a}^{{d}^{h - k} {x}_{k}} ,$$

based on the qudit dimensionality d, the random integer a, and the recycling step k. For each step,

$${\hat{U}}_{a}^{{d}^{h - k} {x}_{k}}$$

is constructed a priori by the classical values

$${a}^{{d}^{h - k} {x}_{k}}$$

mod N. The output state after MEF encoding reads as Equation (3).

$${{\frac{1}{\sqrt{d}} {\sum }_{{x}_{k} = 0}^{d - 1} \vert {x}_{k} 〉}_{c t r l} {\hat{U}}_{a}^{{d}^{h - k} {x}_{k}} \vert {x}_{k} 〉}_{t a r} \qquad ( 3 )$$

In the example stated above, the two recycling steps required for N=15 factorization using 16-level qudits are implemented by the unitary operations represented as the identity

$${{( {\hat{U}}_{a}^{16 {x}_{1}} : \vert 1 〉}_{tar} ↦ \vert 1 〉}_{tar} )$$

for the first step, and

$${{{\hat{U}}_{a}^{{x}_{2}} : \vert 1 〉}_{tar} ↦ \vert {a}^{{x}_{2}} mod 15 〉}_{tar}$$

for the second step. This simplified quantum circuit design for MEF encoding can be universally applied to factor larger numbers, providing optimized, resource-efficient means for Shor's algorithm implementation.

Following this, the phase operator \hat{P}ₖ=diag[1,e^{2πiφ}^{ₖ}, . . . , e^{2πi(d-1)φ}^{ₖ}] and a d-level inverse-QFT

$${\hat{F}}_{d}^{†}$$

is applied to the control register, giving the state defined by Equation (4).

$${{\frac{1}{\sqrt{d}} {\sum }_{{x}_{k} = 0}^{d - 1} ( {\hat{F}}_{d}^{†} {\hat{P}}_{k} \vert {x}_{k} 〉}_{c t r l} ) {\hat{U}}_{a}^{{d}^{h - k} {x}_{k}} \vert {ψ}_{k} 〉}_{t a r} \qquad ( 4 )$$

The control register state is measured in the computational (generalized Pauli Z) basis, and the resulting outcome provides the input target register state for the subsequent recycling step, |ψₖ₊₁ [symbol] ₜₐᵣ. The phase factor in Pk is determined by

$${ϕ}_{k} = - {\sum }_{l = 1}^{k - 1} {v}_{l} / {d}^{k - l + 1} ,$$

where vₗ corresponds to measurement outcomes obtained from the previous l recycling steps. The recycling process continues until the final (h^{th}) step, giving a precision of ┌2 log_{d} N┐ units for the factorization of N. The computational results are represented by a base-d number

$$M = {\sum }_{k = 1}^{h} {d}^{k - 1} {v}_{k} ,$$

from which the period r for a randomly chosen integer a is determined by applying the continued fraction expansion algorithm. The period is then used to compute the greatest common divisor gcd (a^{r/2}±1, N) to identify potential prime factors of N. Full information on the qudit-based iterative Shor's algorithm is detailed below.

As discussed above FIG. 5 depicts a Schematic 500 of a prototype photonic implementation of a qudit-iterative processor according to an embodiment of the invention which employs a CW Laser 511 as a single-photon source. The target register state |1 [symbol] ₜₐᵣ is prepared in the time domain by carving the CW light into a pulse using an Amplitude Modulator 512 driven by a first Control Circuit 514, e.g. an arbitrary waveform generator (AWG). The control register state

$${( 1 / \sqrt{d} ) {\sum }_{{x}_{k} = 0}^{d - 1} \vert {x}_{k} 〉}_{ctrl}$$

is prepared in the frequency domain by modulating the pulsed light to generate a frequency comb spectrum. To implement the simplified MEF circuit detailed above, the inventors employ 16-level qudits for both registers, requiring two recycling steps for N=15 factorization. The unitary operation

$${\hat{U}}_{a}^{{d}^{h - k} {x}_{k}}$$

of the MEF encoding is executed by a 4×16 ProAP-Fil 521, where each output port is assigned sequentially to states spanning |0 [symbol] ₜₐᵣ to |15 [symbol] ₜₐᵣ.

The ProAP-Fil 521 configuration is set to deterministically map the target register state |1 [symbol] ₜₐᵣ to the corresponding output according to the unitary operation

$${{\hat{U}}_{a}^{{d}^{h - k} {x}_{k}} ( given by \vert {a}^{1 {6}^{h - k} {x}_{k}} mod 15 〉}_{tar} )$$

and control register state |xₖ [symbol] _{ctrl} (see discussion below). This approach provides for the direct implementation of the unitary operation required at each recycling step, effectively reducing the MEF circuit depth to 1. The outputs of the ProAP-Fil 521 are then time-multiplexed using a 16×1 beam Combiner 523 with different optical delays implemented with Optical Time Delay Block 522, creating a 16-level time-bin space that meets the target register requirement. The performance of the unitary operations

$${{{\hat{U}}_{a}^{16 {x}_{1}} : \vert 1 〉}_{tar} ↦ \vert 1 〉}_{tar}$$

for the first recycling step and

$${{{\hat{U}}_{a}^{{x}_{2}} : \vert 1 〉}_{tar} ↦ \vert {a}^{{x}_{2}} mod 15 〉}_{tar}$$

for the second recycling step is evaluated by measuring the probability of obtaining the expected outcomes. For all possible random integers a=2, 4, 7, 8, 11, 13, 14 corresponding to N=15 factorization, the average probabilities are 0.936 and 0.924 for the first and second recycling steps, respectively as outlined below.

The next stage involves the implementation of the inverse-QFT in the control register. This is realized via projective measurements in the inverse Fourier basis, facilitated by frequency mixing processes enabled by a phase modulator, second Phase Modulator 531 in FIG. 5. The mixed frequency bin is separated with a filter, e.g. FBG 533, and then detected using a detector, e.g. SNSPD 541. The phase operator Pk is obtained from the results of previous recycling steps, which is then fed to the ProAP-Fil 521 in the next recycling step. For convenience, we implement Pk with the same ProAP-Fil 521 used for the MEF encoding, thereby avoiding an additional insertion loss.

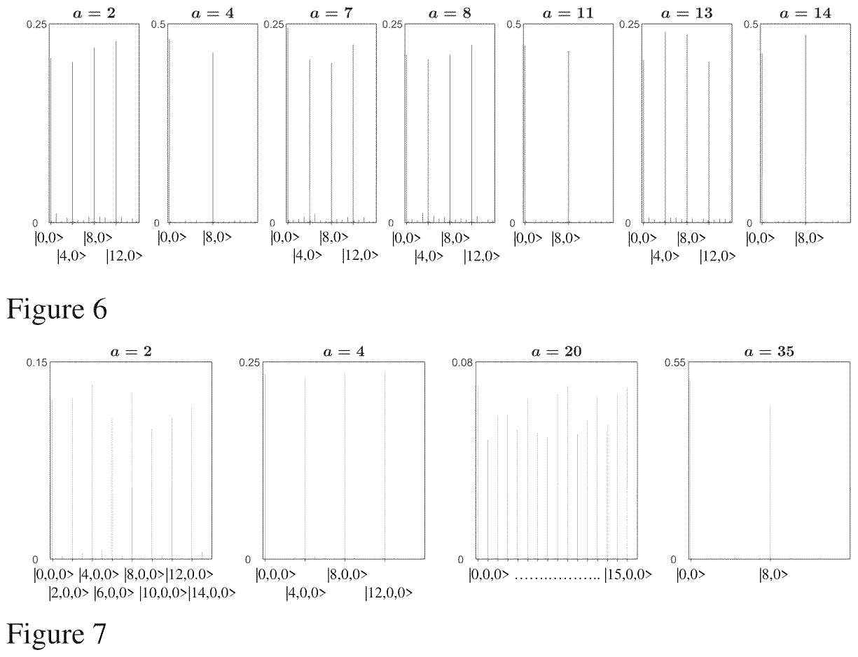

FIG. 6 depicts the N=15 factorization results, with fidelities of 0.859 (14), 0.891(14), 0.876(15), 0.852(20), 0.878(14), 0.886(14), and 0.899(14) for a=2, 4, 7, 8, 11, 13, and 14, respectively, after two recycling steps (as outlined below). The inventors obtain the periods for all random integers using the continued fraction expansion algorithm, providing values of r=4 for a=2, 7, 8, 13, and r=2 for a=4, 11, 14. Using r, the inventors evaluate gcd (a^{r/2}+1, 15), giving prime factors (3,5) for a=2, 4, 7, 8, 11, 13 and trivial factors (1,15) for a=14. These results demonstrate the potential of the presented scheme for the optimal factorization of N=15 using all random integers while fully meeting the computational requirements for Shor's algorithm, and thereby the maximum algorithm precision, i.e., an 8-qubit equivalent precision. Notably, the fidelities (accuracies) can be improved by reducing crosstalk between the ProAP-Fil's output ports. This enhancement is tested by post-selecting the expected computational outcomes using prior knowledge (as outlined below), thereby considering only a subspace of the target register, characterizing this as a compiled approach. The improved fidelities of 0.947(15), 0.958(15), 0.927(16), 0.945(22), 0.953(15), 0.934(15), and 0.957(15) for a=2, 4, 7, 8, 11, and 14, and 14, respectively, demonstrate a notable enhancement in the period-finding process attributed to reduced crosstalk.

To demonstrate the versatility of our approach, we factor N=51 using the same experimental scheme as for N=15 factorization. The number of recycling steps is estimated to be 3 (=┌2 log₁₆ 51┐), requiring MEF encoding implementations given by the unitary operations

$${{{\hat{U}}_{a}^{1 {6}^{2} {x}_{1}} = {\hat{U}}_{a}^{16 {x}_{2}} : \vert 1 〉}_{tar} ↦ \vert 1 〉}_{tar}$$

(identity operation) for the first and second steps, and

$${{{\hat{U}}_{a}^{{x}_{3}} : \vert 1 〉}_{tar} ↦ \vert {a}^{{x}_{3}} mod 51 〉}_{tar}$$

for the final step. For these implementations, the dimension of the target register should exceed 51. However, due to the limited target register space (d=16) in the prototype system, the inventors adopted a compiled approach by post-selecting the expected outcomes using prior knowledge of the solution. The evaluation of the MEF circuit performance is detailed below. While there are 31 possible random integers for N=51 factorization (as outlined below), the inventors limit their demonstration to a subset producing distinct periods r. Here, the inventors employ the MEF for a=2, 4, 20, and 35, resulting in fidelities (after post-selection) of 0.926(7), 0.940(8), 0.920(6), and 0.929(10), for a=2, 4, 20 and 35 respectively, corresponding to the measurement outcomes shown in FIG. 7. Using the continued fraction expansion algorithm, the inventors extract r=8 for a=2, r=4 for a=4, r=16 for a=20, and r=2 for a=35, returning two prime factors gcd (a^{r/2}+1,51)=3, 17.

The inventors' prototype photonic quantum processor demonstrates the successful implementation of iterative Shor's algorithm using qudits, efficiently factorizing N=15 without prior knowledge for constructing computational procedure. By leveraging the greater information capacity of qudits and employing a judicious recycling strategy, the inventors have significantly reduced the number of quantum resources and recycling steps for achieving high-fidelity factorization outcomes. This method not only meets the computational requirements but also simplifies the overall quantum circuit design, showing great promise for practical quantum computing applications.

Within the inventive system only two 16-level qudits are employed to satisfy the dimensionality requirements of the two quantum registers, compared to 12 qubits needed by prior art approaches. The deterministic MEF encoding in a single step, facilitated by simultaneous qudit encoding in the time and frequency DoFs, maximizes the resource efficiency of Shor's algorithm. To the best of the inventors knowledge the inventive prototype photonic quantum processor has provided the first deterministic implementation of MEF encoding in photonics. The inventors prototype photonic quantum processor achieves a precision equivalent to 8 qubits as outlined below, thus surpassing the 6-qubit precision of the best prior art qudit-based implementation.

The inventors have also demonstrated an extension of the prototype photonic quantum processor to factor N=51, demonstrating the versatility of the MEF encoding process. Due to the limited target register space of the prototype system, this factorization exploits a compiled approach that incorporates prior knowledge of the solution.

The experimental results demonstrate that qudit-based quantum systems can execute Shor's algorithm with reduced complexity and greater accuracy, paving the way for robust implementations that substantially outperform previous methods reliant on algorithm compilation. The successful deployment of programmable devices illustrates the adaptability of the inventive prototype photonic quantum processor, making it suitable for factoring larger numbers. Achieving high precision with fewer resources reinforces the effectiveness of qudits as a practical approach relative to qubits, opening new opportunities for efficient and scalable quantum-enhanced integer factorization.

### Experimental Methods

Quantum State Preparation: Within the prototype photonic quantum processor quantum state preparation employs an attenuated continuous wave (CW) laser (CW Laser 511 in FIG. 5) centered at 193.414 THz (1550 nm) as a single-photon source. The initial target register state |1 [symbol] ₜₐᵣ is prepared in the time domain by shaping the CW light into a Gaussian pulse using an amplitude modulator (Amplitude Modulator 512) driven by an arbitrary waveform generator (first Control Circuit 514) at a repetition rate of 12.8 MHz. The control register state

$${( 1 / 4 ) {\sum }_{{x}_{k} = 0}^{15} \vert {x}_{k} 〉}_{ctrl}$$

is prepared as a frequency comb through phase modulation. This is achieved by sideband generation using a phase modulator (first Phase Modulator 513) driven by a 28 GHz signal generator (second Control Circuit 515). These steps collectively result in the photon state

$$\frac{1}{4} {\sum }_{{x}_{k} = 0}^{15 - 1} \vert {x}_{k} {〉}_{ctrl} \vert 1 {〉}_{tar} .$$

Due to the power handling limit of the modulator, the inventors prototype system can generate a frequency comb with a maximum of sixteen comb lines, corresponding to a 16-level frequency qudit. To prepare an equally superposed frequency qudit state, a suitable amplitude mask is applied using a ProAP-Fil 521. While this step can be alternatively performed by cascading intensity and phase modulators, this method is resource-inefficient, lossy, and requires complex radio-frequency waveforms. Therefore, the inventors opted for the simpler technique by leveraging the programmability of the ProAP-Fil 521. To ensure single-photon operation, we maintain an average photon number of ~0.1.

Accordingly, the photon is injected into the ProAP-Fil 521 where the suitable amplitude mask is to implement the unitary operators

$${\hat{U}}_{a}^{{d}^{h - k} {x}_{k}}$$

for the MEF encoding. As noted within this specification in order to optimize this process, the inventors employ 16-level qudits, necessitating only two recycling steps for factoring N=15. In the first recycling step, the MEF circuit gates correspond to the identity operator for all possible random integers a (according to

$${\hat{U}}_{a}^{16 {x}_{1}} : \vert 1 {〉}_{tar} ↦ \vert 1 {〉}_{tar} ) ,$$

leaving the target register state unchanged as |1 [symbol] ₜₐᵣ. During the final recycling step, the MEF circuit gate transforms

$${\hat{U}}_{a}^{{x}_{2}} : \vert 1 {〉}_{tar} \to \vert {a}^{{x}_{2}} mod 15 {〉}_{tar}$$

when the control register state is |x₂ [symbol] _{ctrl}. This process is carried out by sequentially assigning each output port of the ProAP-Fil to states ranging from |0 [symbol] ₜₐᵣ to |15 [symbol] ₜₐᵣ and mapping the state |1 [symbol] ₜₐᵣ to the corresponding output state

$$\vert {a}^{1 {6}^{h - k} {x}_{k}} mod N {〉}_{tar} ,$$

based on the control register state |xₖ [symbol] _{ctrl}. Table 1 shows the mapping at each recycling step required for each random integer when factoring 15 using 16-level units.

This method enables the direct implementation of the required unitary operation at each recycling step, thereby deterministically executing the MEF circuit with a circuit depth of one. The ProAP-Fil 521 outputs, as depicted in FIG. 4 are then time-multiplexed using a 16×1 beam Combiner 523 after the application of appropriate optical time delays to the outputs of the ProAP-Fil 521 by the Optical Time Delay Block 522, forming a 16-level time-bin structure that fulfills the target register requirements.

Subsequently, the phase operator \hat{P}ₖ followed by the inverse-QFT is applied to the control register. The phase operator as previously outlined is realized via phase modulation within the ProAP-Fil 521 employed for the MEF encoding. Details on the phase information are presented in Table 2.

The inverse-QFT

$${\hat{F}}_{d}^{†}$$

is then implemented by projective measurement through a frequency mixing process which is facilitated by the second Phase Modulator 531 in FIG. 5 driven by a 28 GHz signal generator, with specific phase modulation required for each projection basis applied through the ProAP-Fil 521. Table 3 shows the phase information required for each basis. The mixed frequencies are filtered using the FBG 533 in combination with the Circulator 534 and then detected by the SNSPD 541. The timing information is captured using the TCSPC 542. Subsequently, the measurement results are recorded on a conventional computer and then fed-forward to the ProAP-Fil 521 to implement the phase operator \hat{P}ₖ₊₁ in the next (k+1)^{th} recycling step.

TABLE 1
Target Register Mapping at Each Recycling Step for
Factoring 15 using 16-Level Units

| | a = 2 | | a = 4 | | a = 7 | | a = 8 | |
|---|---|---|---|---|---|---|---|---|
| xₖ | ${\hat{U}}_{a = 2}^{16 {x}_{1}}$ | ${\hat{U}}_{a = 2}^{{x}_{2}}$ | ${\hat{U}}_{a = 4}^{16 {x}_{1}}$ | ${\hat{U}}_{a = 4}^{{x}_{2}}$ | ${\hat{U}}_{a = 7}^{16 {x}_{1}}$ | ${\hat{U}}_{a = 7}^{{x}_{2}}$ | ${\hat{U}}_{a = 8}^{16 {x}_{1}}$ | ${\hat{U}}_{a = 8}^{{x}_{2}}$ |
| 0 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 1 | \|1 [symbol] ₜₐᵣ | \|2 [symbol] ₜₐᵣ | \|1 [symbol] ₜₐᵣ | \|4 [symbol] ₜₐᵣ | \|1 [symbol] ₜₐᵣ | \|7 [symbol] ₜₐᵣ | \|1 [symbol] ₜₐᵣ | \|8 [symbol] ₜₐᵣ |
| 2 | \|1 [symbol] ₜₐᵣ | \|4 [symbol] ₜₐᵣ | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|4 [symbol] ₜₐᵣ |
| 3 | \|1 [symbol] ₜₐᵣ | \|8 [symbol] ₜₐᵣ | \|1 [symbol] ₜₐᵣ | \|4 [symbol] ₜₐᵣ | \|1 [symbol] ₜₐᵣ | \|13 [symbol] ₜₐᵣ | \|1 [symbol] ₜₐᵣ | \|2 [symbol] ₜₐᵣ |
| 4 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 5 | \|1 [symbol] ₜₐᵣ | \|2 [symbol] ₜₐᵣ | \|1 [symbol] ₜₐᵣ | \|4 [symbol] ₜₐᵣ | \|1 [symbol] ₜₐᵣ | \|7 [symbol] ₜₐᵣ | \|1 [symbol] ₜₐᵣ | \|8 [symbol] ₜₐᵣ |
| 6 | \|1 [symbol] ₜₐᵣ | \|4 [symbol] ₜₐᵣ | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|4 [symbol] ₜₐᵣ |
| 7 | \|1 [symbol] ₜₐᵣ | \|8 [symbol] ₜₐᵣ | \|1 [symbol] ₜₐᵣ | \|4 [symbol] ₜₐᵣ | \|1 [symbol] ₜₐᵣ | \|13 [symbol] ₜₐᵣ | \|1 [symbol] ₜₐᵣ | \|2 [symbol] ₜₐᵣ |
| 8 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 9 | \|1 [symbol] ₜₐᵣ | \|2 [symbol] ₜₐᵣ | \|1 [symbol] ₜₐᵣ | \|4 [symbol] ₜₐᵣ | \|1 [symbol] ₜₐᵣ | \|7 [symbol] ₜₐᵣ | \|1 [symbol] ₜₐᵣ | \|8 [symbol] ₜₐᵣ |
| 10 | \|1 [symbol] ₜₐᵣ | \|4 [symbol] ₜₐᵣ | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|4 [symbol] ₜₐᵣ |
| 11 | \|1 [symbol] ₜₐᵣ | \|8 [symbol] ₜₐᵣ | \|1 [symbol] ₜₐᵣ | \|4 [symbol] ₜₐᵣ | \|1 [symbol] ₜₐᵣ | \|13 [symbol] ₜₐᵣ | \|1 [symbol] ₜₐᵣ | \|2 [symbol] ₜₐᵣ |
| 12 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 13 | \|1 [symbol] ₜₐᵣ | \|2 [symbol] ₜₐᵣ | \|1 [symbol] ₜₐᵣ | \|4 [symbol] ₜₐᵣ | \|1 [symbol] ₜₐᵣ | \|7 [symbol] ₜₐᵣ | \|1 [symbol] ₜₐᵣ | \|8 [symbol] ₜₐᵣ |
| 14 | \|1 [symbol] ₜₐᵣ | \|4 [symbol] ₜₐᵣ | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|4)ₜₐᵣ |
| 15 | \|1 [symbol] ₜₐᵣ | \|8 [symbol] ₜₐᵣ | \|1 [symbol] ₜₐᵣ | \|4 [symbol] ₜₐᵣ | \|1 [symbol] ₜₐᵣ | \|13 [symbol] ₜₐᵣ | \|1 [symbol] ₜₐᵣ | \|2 [symbol] ₜₐᵣ |

| | | |
|---|---|---|
| a = 11 | a = 13 | a = 14 |

| xₖ | ${\hat{U}}_{a = 11}^{16 {x}_{1}}$ | ${\hat{U}}_{a = 11}^{{x}_{2}}$ | ${\hat{U}}_{a = 13}^{16 {x}_{1}}$ | ${\hat{U}}_{a = 13}^{{x}_{2}}$ | ${\hat{U}}_{a = 14}^{16 {x}_{1}}$ | ${\hat{U}}_{a = 14}^{{x}_{2}}$ |
|---|---|---|---|---|---|---|
| 0 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 1 | \|1 [symbol] ₜₐᵣ | \|11 [symbol] ₜₐᵣ | \|1 [symbol] ₜₐᵣ | \|13 [symbol] ₜₐᵣ | \|1 [symbol] ₜₐᵣ | \|14 [symbol] ₜₐᵣ |
| 2 | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|1 [symbol] ₜₐᵣ |
| 3 | \|1 [symbol] ₜₐᵣ | \|11 [symbol] ₜₐᵣ | \|1 [symbol] ₜₐᵣ | \|7 [symbol] ₜₐᵣ | \|1 [symbol] ₜₐᵣ | \|14 [symbol] ₜₐᵣ |
| 4 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 5 | \|1 [symbol] ₜₐᵣ | \|11 [symbol] ₜₐᵣ | \|1 [symbol] ₜₐᵣ | \|13 [symbol] ₜₐᵣ | \|1 [symbol] ₜₐᵣ | \|14 [symbol] ₜₐᵣ |
| 6 | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|1 [symbol] ₜₐᵣ |
| 7 | \|1 [symbol] ₜₐᵣ | \|11 [symbol] ₜₐᵣ | \|1 [symbol] ₐᵣ | \|7 [symbol] ₜₐᵣ | \|1 [symbol] ₜₐᵣ | \|14 [symbol] ₜₐᵣ |
| 8 | \|1 [symbol] ₜₐᵣ | \|1 [symbol] ₜₐᵣ | \|1 [symbol] ₜₐᵣ | \|1 [symbol] ₐᵣ | \|1 [symbol] ₜₐᵣ | \|1 [symbol] ₜₐᵣ |
| 9 | \|1 [symbol] ₜₐᵣ | \|11 [symbol] ₜₐᵣ | \|1 [symbol] ₜₐᵣ | \|13 [symbol] ₜₐᵣ | \|1 [symbol] ₜₐᵣ | \|14 [symbol] ₜₐᵣ |
| 10 | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|1 [symbol] ₜₐᵣ |
| 11 | \|1 [symbol] ₜₐᵣ | \|11 [symbol] ₜₐᵣ | \|1 [symbol] ₜₐᵣ | \|7 [symbol] ₜₐᵣ | \|1 [symbol] ₜₐᵣ | \|14 [symbol] ₜₐᵣ |
| 12 | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ | \|1 [symbol] ₜₐᵣ |
| 13 | \|1 [symbol] ₜₐᵣ | \|11 [symbol] ₜₐᵣ | \|1 [symbol] ₜₐᵣ | \|13 [symbol] ₜₐᵣ | \|1 [symbol] ₜₐᵣ | \|14 [symbol] ₜₐᵣ |
| 14 | \|1 [symbol] ₜₐᵣ | \|1 [symbol] ₜₐᵣ | \|1 [symbol] ₜₐᵣ | \|4 [symbol] ₜₐᵣ | \|1 [symbol] ₜₐᵣ | \|1 [symbol] ₜₐᵣ |
| 15 | \|1 [symbol] ₜₐᵣ | \|11 [symbol] ₜₐᵣ | \|1 [symbol] ₜₐᵣ | \|7 [symbol] ₜₐᵣ | \|1 [symbol] ₜₐᵣ | \|14 [symbol] ₜₐᵣ |

TABLE 2
Phase Information used for the Phase Operator.

| | v₁ | | | | | | | |
|---|---|---|---|---|---|---|---|---|
| \|x₂ [symbol] _{ctrl} | 0 | 1 | 2 | 3 | 4 | 5 | 6 | 7 |
| \|0 [symbol] | 0 | 0 | 0 | 0 | 0 | 0 | 0 | 0 |
| \|1 [symbol] | 0 | −0.02 | −0.05 | −0.07 | −0.1 | −0.12 | −0.15 | −0.17 |
| \|2 [symbol] | 0 | −0.05 | −0.1 | −0.14 | −0.2 | −0.25 | −0.29 | −0.34 |
| \|3 [symbol] | 0 | −0.07 | −0.15 | −0.22 | −0.3 | −0.37 | −0.44 | −0.52 |
| \|4 [symbol] | 0 | −0.1 | −0.2 | −0.29 | −0.39 | −0.49 | −0.59 | −0.69 |
| \|5 [symbol] | 0 | −0.12 | −0.25 | −0.37 | −0.49 | −0.61 | −0.74 | −0.86 |
| \|6 [symbol] | 0 | −0.14 | −0.29 | −0.44 | −0.59 | −0.74 | −0.88 | −1.03 |
| \|7 [symbol] | 0 | −0.17 | −0.34 | −0.52 | −0.69 | −0.86 | −1.03 | −1.2 |
| \|8 [symbol] | 0 | −0.2 | −0.39 | −0.59 | −0.79 | −0.98 | −1.18 | −1.37 |
| \|9 [symbol] | 0 | −0.22 | −0.44 | −0.66 | −0.88 | −1.1 | −1.33 | −1.55 |
| \|10 [symbol] | 0 | −0.25 | −0.49 | −0.74 | −0.98 | −1.23 | −1.47 | −1.72 |
| \|11 [symbol] | 0 | −0.27 | −0.54 | −0.8 | −1.08 | −1.35 | −1.62 | −1.89 |
| \|12 [symbol] | 0 | −0.29 | −0.58 | −0.88 | −1.18 | −1.47 | −1.77 | −2.06 |
| \|13 [symbol] | 0 | −0.32 | −0.64 | −0.96 | −1.28 | −1.6 | −1.91 | −2.23 |
| \|14 [symbol] | 0 | −0.34 | −0.69 | −1.03 | −1.37 | −1.72 | −2.06 | −2.41 |
| \|15 [symbol] | 0 | −0.37 | −0.74 | −1.1 | −1.47 | −1.84 | −2.21 | −2.58 |

| | v₁ | | | | | | | |
|---|---|---|---|---|---|---|---|---|
| \|x₂ [symbol] _{ctrl} | 8 | 9 | 10 | 11 | 12 | 13 | 14 | 15 |
| \|0 [symbol] | 0 | 0 | 0 | 0 | 0 | 0 | 0 | 0 |
| \|1 [symbol] | −0.2 | −0.22 | −0.25 | −0.27 | −0.29 | −0.32 | −0.34 | −0.37 |
| \|2 [symbol] | −0.39 | −0.44 | −0.49 | −0.54 | −0.59 | −0.64 | −0.69 | −0.74 |
| \|3 [symbol] | −0.59 | −0.66 | −0.74 | −0.81 | −0.88 | −0.96 | −1.03 | −1.1 |
| \|4 [symbol] | −0.79 | −0.88 | −0.98 | −1.08 | −1.18 | −1.28 | −1.37 | −1.47 |
| \|5 [symbol] | −0.98 | −1.1 | −1.23 | −1.35 | −1.47 | −1.6 | −1.72 | −1.84 |
| \|6 [symbol] | −1.18 | −1.33 | −1.47 | −1.62 | −1.77 | −1.91 | −2.06 | −2.21 |
| \|7 [symbol] | −1.37 | −1.55 | −1.72 | −1.89 | −2.06 | −2.23 | −2.41 | −2.58 |
| \|8 [symbol] | −1.57 | −1.77 | −1.96 | −2.16 | −2.36 | −2.55 | −2.75 | −2.95 |
| \|9 [symbol] | −1.77 | −1.99 | −2.21 | −2.43 | −2.65 | −2.87 | −3.09 | −3.31 |
| \|10 [symbol] | −1.96 | −2.21 | −2.45 | −2.7 | −2.95 | −3.19 | −3.44 | −3.68 |
| \|11 [symbol] | −2.16 | −2.43 | −2.70 | −2.97 | −3.24 | −3.51 | −3.78 | −4.05 |
| \|12 [symbol] | −2.36 | −2.65 | −2.95 | −3.24 | −3.53 | −3.83 | −4.12 | −4.42 |
| \|13 [symbol] | −2.55 | −2.87 | −3.19 | −3.51 | −3.83 | −4.15 | −4.47 | −4.79 |
| \|14 [symbol] | −2.75 | −3.09 | −3.44 | −3.78 | −4.12 | −4.47 | −4.81 | −5.15 |
| \|15 [symbol] | −2.95 | −3.31 | −3.68 | −4.05 | −4.42 | −4.79 | −5.15 | −5.52 |

v₁ represents the measurement result from the first recycling step, which is used to adjust the phase operator during the second recycling step. Each phase is applied to the corresponding control register state |x₂ [symbol] _{ctrl}. The phase values are presented in radians.

TABLE 3
Phase Information of Inverse-QFT Bases.

| | Basis | | | | | | | |
|---|---|---|---|---|---|---|---|---|
| \|xₖ [symbol] _{ctrl} | 0 | 1 | 2 | 3 | 4 | 5 | 6 | 7 |
| \|0 [symbol] | 0 | 0 | 0 | 0 | 0 | 0 | 0 | 0 |
| \|1 [symbol] | 0 | −0.39 | −0.79 | −1.18 | −1.57 | −1.96 | −2.36 | −2.75 |
| \|2 [symbol] | 0 | −0.79 | −1.57 | −2.36 | 3.14 | 2.36 | 1.57 | 0.79 |
| \|3 [symbol] | 0 | −1.18 | −2.36 | 2.75 | 1.57 | 0.39 | −0.79 | −1.96 |
| \|4 [symbol] | 0 | −1.57 | 3.14 | 1.57 | 0 | −1.57 | 3.14 | 1.57 |
| \|5 [symbol] | 0 | −1.96 | 2.36 | 0.39 | −1.57 | 2.75 | 0.79 | −1.18 |
| \|6 [symbol] | 0 | −2.36 | 1.57 | −0.79 | 3.14 | 0.79 | −1.57 | 2.36 |
| \|7 [symbol] | 0 | −2.75 | 0.79 | −1.96 | 1.57 | −1.18 | 2.36 | −0.39 |
| \|8 [symbol] | 0 | 3.14 | 0 | 3.14 | 0 | 3.14 | 0 | 3.14 |
| \|9 [symbol] | 0 | 2.75 | −0.79 | 1.96 | −1.57 | 1.18 | −2.36 | 0.39 |
| \|10 [symbol] | 0 | 2.36 | −1.57 | 0.79 | 3.14 | −0.79 | 1.57 | −2.36 |
| \|11 [symbol] | 0 | 1.96 | −2.36 | −0.39 | 1.57 | −2.75 | −0.79 | 1.18 |
| \|12 [symbol] | 0 | 1.57 | 3.14 | −1.57 | 0 | 1.57 | 3.14 | −1.57 |
| \|13 [symbol] | 0 | 1.18 | 2.36 | −2.75 | −1.57 | −0.39 | 0.79 | 1.96 |
| \|14 [symbol] | 0 | 0.79 | 1.57 | 2.36 | 3.14 | −2.36 | −1.57 | −0.79 |
| \|15 [symbol] | 0 | 0.39 | 0.79 | 1.18 | 1.57 | 1.96 | 2.36 | 2.75 |

| | Basis | | | | | | | |
|---|---|---|---|---|---|---|---|---|
| \|xₖ [symbol] _{ctrl} | 8 | 9 | 10 | 11 | 12 | 13 | 14 | 15 |
| \|0 [symbol] | 0 | 0 | 0 | 0 | 0 | 0 | 0 | 0 |
| \|1 [symbol] | 3.14 | 2.75 | 2.36 | 1.96 | 1.57 | 1.18 | 0.79 | 0.39 |
| \|2 [symbol] | 0 | −0.79 | −1.57 | −2.36 | 3.14 | 2.36 | 1.57 | 0.79 |
| \|3 [symbol] | 3.14 | 1.96 | 0.79 | −0.39 | −1.57 | −2.75 | 2.36 | 1.18 |
| \|4 [symbol] | 0 | −1.57 | 3.14 | 1.57 | 0 | −1.57 | 3.14 | 1.57 |
| \|5 [symbol] | 3.14 | 1.18 | −0.79 | −2.75 | 1.57 | −0.39 | −2.36 | 1.96 |
| \|6 [symbol] | 0 | −2.36 | 1.57 | −0.79 | 3.14 | 0.79 | −1.57 | 2.36 |
| \|7 [symbol] | 3.14 | 0.39 | −2.36 | 1.18 | −1.57 | 1.96 | −0.79 | 2.75 |
| \|8 [symbol] | 0 | 3.14 | 0 | 3.14 | 0 | 3.14 | 0 | 3.14 |
| \|9 [symbol] | 3.14 | −0.39 | 2.36 | −1.18 | 1.57 | −1.96 | 0.79 | −2.75 |
| \|10 [symbol] | 0 | 2.36 | −1.57 | 0.79 | 3.14 | −0.79 | 1.57 | −2.36 |
| \|11 [symbol] | 3.14 | −1.18 | 0.79 | 2.75 | −1.57 | 0.39 | 2.36 | −1.96 |
| \|12 [symbol] | 0 | 1.57 | 3.14 | −1.57 | 0 | 1.57 | 3.14 | −1.57 |
| \|13 [symbol] | 3.14 | −1.96 | −0.79 | 0.39 | 1.57 | 2.75 | −2.36 | −1.18 |
| \|14 [symbol] | 0 | 0.79 | 1.57 | 2.36 | 3.14 | −2.36 | −1.57 | −0.79 |
| \|15 [symbol] | 3.14 | −2.75 | −2.36 | −1.96 | −1.57 | −1.18 | −0.79 | −0.39 |

This table outlines the phase values applied to the corresponding control register states for each basis. The phase values are presented in radians.

Circuit Implementation for N=15 Factorization: For N=15 factorization, the unitary operations

$${\hat{U}}_{a}^{1 {6}^{h - k} {x}_{k}} ,$$

given by

$${\hat{U}}_{a}^{16 {x}_{1}} : \vert 1 {〉}_{tar} ↦ \vert 1 {〉}_{tar} and {\hat{U}}_{a}^{{χ}_{2}} : \vert 1 {〉}_{tar} ↦ \vert {a}^{{x}_{2}} mod 15 {〉}_{tar}$$

in the first and second recycling steps, respectively, are implemented using a 4×16 ProAP-Fil 521. These unitary operations are applied to the time qudit state |1 [symbol] ₜₐᵣ in the target register based on the frequency qudit state in the control register |xₖ [symbol] _{ctrl}. For example,

$${\hat{U}}_{a = 2}^{{x}_{2}}$$

for factoring N=15 in the second recycling step performs the mapping |x₂ [symbol] _{ctrl}|1 [symbol] ₜₐᵣ [symbol] |x₂ [symbol] _{ctrl}|2^{x}^{₂} mod 15 [symbol] ₜₐᵣ. To implement this, we sequentially assign the output ports of the ProAP-Fil 521 to states |0 [symbol] ₜₐᵣ to |15 [symbol] ₜₐᵣ and program the ProAP-Fil 521 to conditionally map the initial time qudit state |1 [symbol] ₜₐᵣ to the corresponding target register state

$$\vert {a}^{1 {6}^{h - k} {x}_{k}} mod N {〉}_{tar} .$$

### For

$${\hat{U}}_{a = 2}^{{x}_{2}} ,$$

this results in mapping the initial target register state |1 [symbol] ₜₐᵣ into: |1 [symbol] ₜₐᵣ if |x₂ [symbol] _{ctrl}=|0/4/8/12 [symbol] _{ctrl}, into |2 [symbol] ₜₐᵣ if |x₂ [symbol] _{ctrl}=|1/5/9/13 [symbol] _{ctrl}, into |4 [symbol] ₜₐᵣ if |x₂ [symbol] _{ctrl}=|Feb. 6, 2010/14 [symbol] _{ctrl}, and into |8 [symbol] ₜₐᵣ if |x₂ [symbol] _{ctrl}=|3/7/11/15 [symbol] _{ctrl}. This mapping can be performed for all random integers a through the ProAP-Fil 521. The presented approach enables deterministic encoding of the MEF to the target register, with the performance details of the MEF circuit as outlined below.

Inverse-OFT implementation: To simplify the inverse-QFT process, we directly measure the outputs from the MEF circuit in the inverse quantum Fourier basis as given by Equation (5).

$$\vert {f}_{j} 〉 = \frac{1}{4} {\sum }_{z = 0}^{15} {e}^{- 2 π izj / 16} \vert z 〉 ( j = 0 , 1 , … , 15 ) \qquad ( 5 )$$

In the prototype photonic quantum processor, the inverse-QFT process is implemented probabilistically by projective measurements using a frequency mixing technique with a phase modulator (second Phase Modulator 531) driven by a 28 GHz signal generator (third Control Circuit 532). While deterministic inverse-QFT can be achieved by cascading ProAP-Fils and phase modulators, this method results in significant loss and requires high-order radio-frequency harmonics for phase modulation. Both methods perform equivalently, although the probabilistic scheme requires longer measurement times to acquire sufficient photon statistics.

To reduce the complexity and insertion loss of the system, the inventors change the projection frame of the inverse Fourier basis by tuning the relative phases between frequency bins using the ProAP-Fil 521 employed for the state preparation. The mixed frequency is then filtered out using a fiber Bragg grating (FBG 533) with a bandwidth of 5 GHz and is measured using a detector (SNSPD 541) and a time-correlated single-photon counting unit (TCSPC 542).

Verification of Crosstalk Effects in the Programmable Amplitude and Phase Shifter (ProAP-Fil): In order to evaluate the effect of crosstalk from the ProAP-Fil 521 employed for the programmable amplitude and phase shift on fidelity estimation, the inventors post-select only the correct measurement outcomes of the MEF encoding process at each recycling step. For instance, when using a=2, we post-select only the state |1 [symbol] ₜₐᵣ for the 1^{st} recycling step, and the states |1 [symbol] ₜₐᵣ, |2 [symbol] ₜₐᵣ, |4 [symbol] ₜₐᵣ, and |8 [symbol] ₜₐᵣ for the final recycling step. These outcomes can be predicted for all random integers by relying on prior knowledge of the solutions, thus offering a compiled method for enhancing fidelity in our scheme.

Fidelity Estimation of Shor's Algorithm: The fidelity of the period finding process is evaluated as 1−σ_{D}, where σ_{D} is the trace distance or the Kolmogorov distance. The term OD provides an estimate on the closeness between the experimental and theoretical probability distributions, y_{z} and e_{z}, respectively. It is defined as σ_{D}(y_{z}, e_{z})=(½)Σ_{z}|y_{z}−e_{z}|, where z represents all possible output states.

Target Register Compilation for N=51 Factorization: As the prototype photonic quantum processor supports a maximum of 16-level qudits, the factorization of N=51 requires compilation of the target register as detailed below. Yet, this scheme does not demand hardware modifications, however, requires three recycling steps for optimal computing precision. The MEF encoding implementations are given by the unitary operations

$${\hat{U}}_{a}^{1 {6}^{2} {x}_{1}} = {\hat{U}}_{a}^{16 {x}_{2}} : \vert 1 {〉}_{tar} ↦ \vert 1 {〉}_{tar}$$

for the first and second steps, and

$${\hat{U}}_{a}^{{x}_{3}} : \vert 1 {〉}_{tar} ↦ \vert {a}^{{x}_{3}} mod 51 {〉}_{tar}$$

for the final step. The MEFs are programmed into the ProAP-Fil, similar to the implementation for N=15 factorization, and the outputs are post-selected according to the expected outcomes. For

$${\hat{U}}_{a = 4}^{{x}_{3}} ,$$

this results in mapping the initial target register state |1 [symbol] ₜₐᵣ into: |1 [symbol] ₜₐᵣ if |x₃ [symbol] _{ctrl}=|0/4/8/12 [symbol] _{ctrl}, into |4 [symbol] ₜₐᵣ if |x₃ [symbol] _{ctrl}=|1/5/9/13 [symbol] _{ctrl}, into |16 [symbol] ₜₐᵣ if |x₃ [symbol] _{ctrl}=|2/6/10/14 [symbol] _{ctrl}, and into |13 [symbol] ₜₐᵣ if |x₃ [symbol] _{ctrl}=|3/7/11/15 [symbol] _{ctrl}. The target register states |1 [symbol] ₜₐᵣ, |4 [symbol] ₜₐᵣ, |16 [symbol] ₜₐᵣ, |13 [symbol] ₜₐᵣ are mapped into the ProAP-Fil's outputs in ascending order such that |1 [symbol] ₜₐᵣ→|0 [symbol] ₜₐᵣ, |4 [symbol] ₜₐᵣ→|1 [symbol] ₜₐᵣ, |16 [symbol] ₜₐᵣ→|3 [symbol] ₜₐᵣ, |13 [symbol] ₜₐᵣ→|2 [symbol] ₜₐᵣ, and then measured. Given that all random integers a satisfy the period condition a¹⁶ mod 51=1, this mapping can be fully implemented using a d=16 target register space.

### Qudit-Based Shor's Algorithm

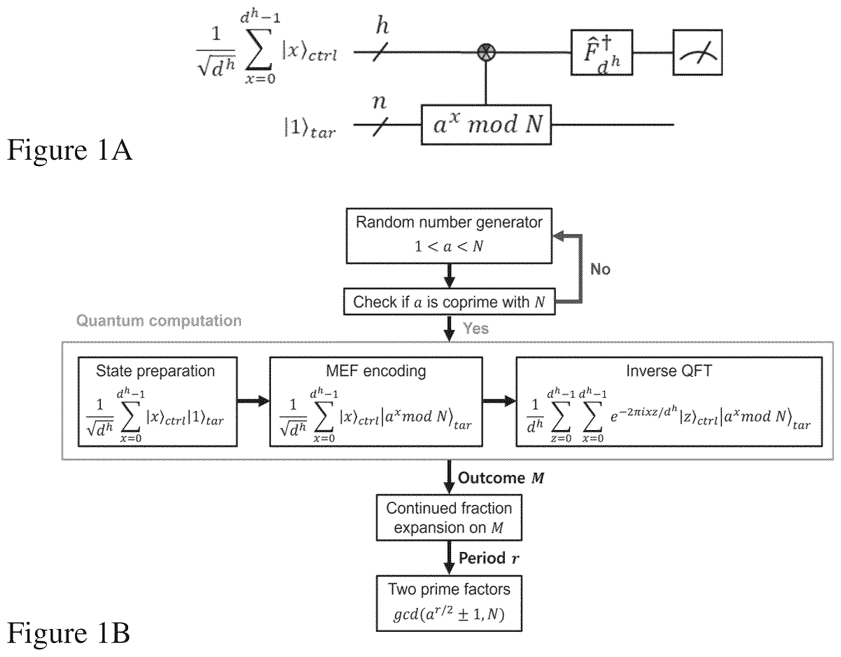

FIG. 1A depicts a circuit diagram of the qudit-based implementation of Shor's algorithm. The control and target register states are prepared to be

$$\frac{1}{\sqrt{{d}^{h}}} {\sum }_{x = 0}^{{d}^{h} - 1} \vert x {〉}_{ctrl} and \vert 0 {〉}_{tar}^{⊗ n - 1} \vert 1 {〉}_{tar} ,$$

respectively. The MEF, a^{x} mod N, is applied to the target register state when the control register state is |x [symbol] _{ctrl}.

$${\hat{F}}_{{d}^{h}}^{†}$$

is the d^{h}-level inverse QFT. The computing results are measured in the computational basis in the control register.

FIG. 1B depicts a process flow for the implementation of the original Shor's algorithm process. The algorithm begins by extracting the period r of the MEF, defined as a^{x} mod N, where a is a random integer that is coprime with N and satisfies 1<a<N. The period-finding process involves multiple units across both registers: a control register with h=┌2 log_{d} N┐ units to store the computational outcome and a target register with n=┌log_{d} N┐ units to compute period of the MEF, with d representing the dimensionality/level of the quantum units. For example, when factoring the number N=15 with qubits (d=2), a minimum of h=8 qubits are required for the control (ctrl) register and n=4 qubits for the target (tar) register. The control and target registers are initially prepared in the state

$$\frac{1}{\sqrt{{d}^{h}}} {\sum }_{x = 0}^{{d}^{h} - 1} \vert x {〉}_{ctrl}$$

and |1 [symbol] ₜₐᵣ, respectively, in decimal representation, resulting in the total state given by Equation (6).

Subsequently, the MEF is encoded by applying the operator

$${\hat{U}}_{a}^{x} \text{:} \vert 1 {〉}_{tar} \to \vert {a}^{x} mod N {〉}_{tar}$$

to the target register state x times when the control register is in the state |x [symbol] _{ctrl}, thus yielding the state given in Equation (7). Finally, a d^{h}-level inverse-QFT,

$${\hat{F}}_{{d}^{h}}^{†} = \frac{1}{\sqrt{{d}^{h}}} {\sum }_{x = 0}^{{d}^{h} - 1} {e}^{- 2 π ixz / {d}^{h}} \vert z 〉 〈 x \vert ,$$

is applied to the control register, resulting in the state given by Equation (8).

$$\frac{1}{\sqrt{{d}^{h}}} {\sum }_{x = 0}^{{d}^{h} - 1} \vert x {〉}_{ctrl} \vert 1 {〉}_{tar} \qquad ( 6 )$$

$$\frac{1}{\sqrt{{d}^{h}}} {\sum }_{x = 0}^{{d}^{h} - 1} \vert x {〉}_{ctrl} \vert {a}^{x} mod N {〉}_{tar} \qquad ( 7 )$$

$$\frac{1}{{d}^{h}} {\sum }_{z = 0}^{{d}^{h} - 1} {\sum }_{x = 0}^{{d}^{h} - 1} {e}^{- 2 π ixz / {d}^{h}} \vert z {〉}_{ctrl} \vert {a}^{x} mod N {〉}_{tar} \qquad ( 8 )$$

Here, |z [symbol] _{ctrl} denotes the final state of the control register after inverse-QFT. The control register is measured in the computational basis of |z [symbol] _{ctrl}, yielding the computational result as a base-d number M. For example, let us consider the case of factoring N=15 with two 16-level units in the control register (according to h=┌2 log₁₆ 15┐=2 units). If the measurement results of each unit are sequentially |4 [symbol] _{ctrl} and |0 [symbol] _{ctrl}, the final output is represented as |4, 0 [symbol] _{ctrl}, which corresponds to M=40₁₆ in hexadecimal (base-16) representation. The continued fraction expansion algorithm (see below) is applied to the measurement result M provide the period r of a given MEF, which is then used to compute the greatest common divisor gcd (a^{r/2}±1,N), revealing two potential prime factors of N. Note that the measurement and data processing procedures are equivalent in the iterative approach detailed below. The original approach has been demonstrated by factoring the number 15 using nuclear magnetic resonance, superconductors and photonics. However, the period-finding process in these demonstrations utilized prior knowledge of the factorization result to overcome the substantial resource requirements. One of the main challenges with Shor's algorithm lies in the need to represent large numbers in quantum registers, which can demand a significant number of quantum units, especially as the size of the integer to be factored increases. To mitigate this, previous experiments employed techniques that reduced the number of units by exploiting prior knowledge of the factors. For example, by knowing information about the factors or assuming certain properties of the numbers involved, they could bypass the full quantum period-finding subroutine or reduce the size of the quantum register. This approach allowed for a simplified version of the algorithm to be implemented with fewer units, albeit at the cost of undermining the generality of the algorithm's factorization capability. While these techniques demonstrated proof-of-principle implementations of Shor's algorithm, they did not meet the algorithm's full dimensionality and resource requirements, which are necessary for factoring arbitrary large numbers without prior information about the factors.

### Continued Fraction Expansion Algorithm

The continued fraction expansion algorithm is applied to the normalized measurement result M/d^{h} (see for example Nielsen in “Quantum Computation and Quantum Information”, Cambridge Univ. Press, 2000), to give Equation (9) where s₀, s₁, s₂, . . . , sₚ are positive integers. By truncating this continued fraction and discarding the fractional part, we obtain rational approximations for M/d^{h}, known as convergents. The convergents for M/d^{h} are given in Equation (10).

$$\frac{M}{{d}^{h}} ≡ [ {s}_{0} , {s}_{1} , {s}_{2} , … , {s}_{p} ] ≡ {s}_{0} + \frac{1}{{s}_{1} + \frac{1}{{s}_{2} + \frac{1}{⋯ + \frac{1}{{s}_{p}}}}} \qquad ( 9 )$$

$${s}_{0} , {s}_{0} + \frac{1}{{s}_{1}} , {s}_{0} + \frac{1}{{s}_{1} + \frac{1}{{s}_{2}}} , {s}_{0} + \frac{1}{{s}_{1} + \frac{1}{{s}_{2} + \frac{1}{⋯ + \frac{1}{{s}_{p}}}}} \qquad ( 10 )$$

This process provides an efficient method of approximating the real number M/d^{h} for period-finding, where one of the convergents gives the correct period r. The period is then verified using the greatest common divisor, gcd (a^{r/2}±1, N). We apply the continued fraction expansion algorithm to the previous example, where M=40₁₆ (corresponding to 64 in decimal representation) is measured while determining the period of the MEF 2^{x} mod 15 using 8 qubits in the control register. The normalized result is M/d^{h}=64/28, yielding a single convergent ¼, and a period of 4 (given by the denominator). Using this period, the greatest common divisor returns gcd (2^{4/2}±1,15)=3,5, corresponding to the two prime factors of 15.

Qudit-Based Iterative Shor's Algorithm (or Shor's Algorithm with Recycling)

The iterative Shor's algorithm adopts a semi-classical inverse QFT process where each qudit in the control register is measured sequentially to determine the operations (e.g., unitaries) for the next qudit, rather than applying the inverse QFT across all qudits simultaneously. This sequential implementation allows the process to be alternatively performed by recycling a single qudit in the control register.

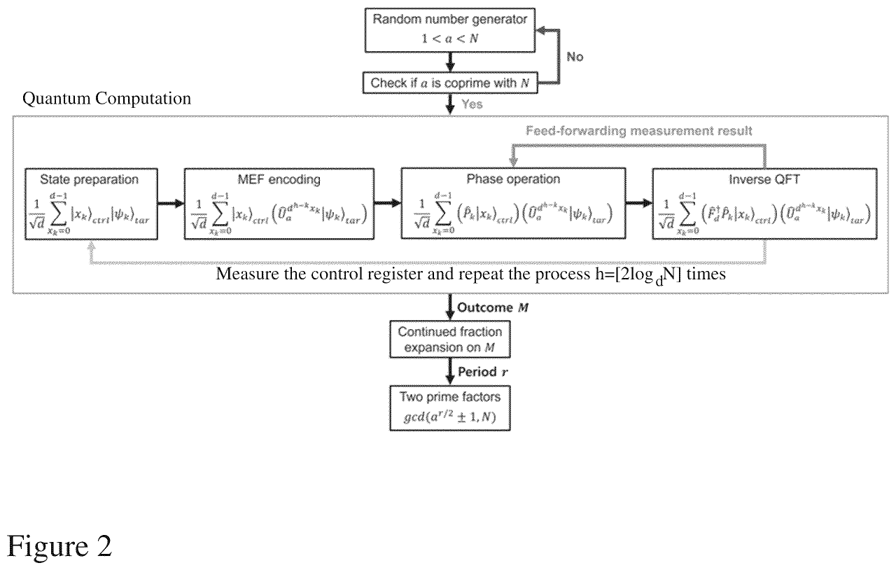

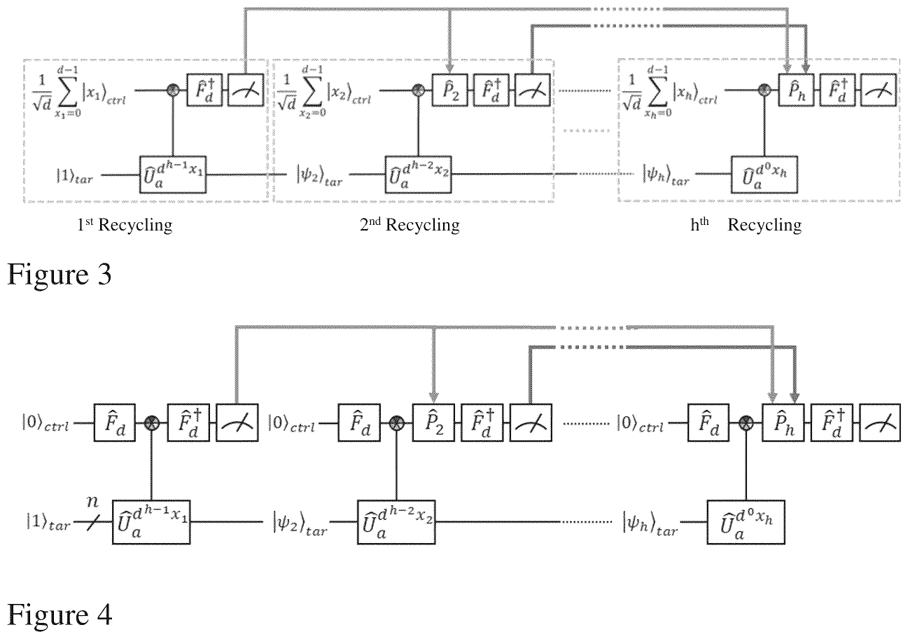

Similar to the original Shor's algorithm, the recycling approach begins by extracting the period r of the MEF. The quantum computation stage, highlighted by the box in FIG. 2, includes four processes, state preparation, MEF encoding, phase operation, and inverse quantum Fourier transform (inverse-QFT). These four processes are repeated h=┌2 log_{d} N┐times to achieve optimal precision for accurate factorization. FIG. 3 shows the quantum computing circuit for the recycling approach. In the state preparation step, the two computational registers, control and target, are initialized based on the general expressions outlined above for Shor's original algorithm. At each recycling step, the states in both registers take the form of Equation (11) where k=1, 2, . . . , h=┌2 log_{d} N┐ represents the recycling step and the initial target register state is set to |ψ₁ [symbol] ₜₐᵣ=|1 [symbol] ₜₐᵣ.

The MEF encoding quantum gate

$${\hat{U}}_{a}^{{d}^{h - k} {x}_{k}} ,$$

designed a priori by classical means (See The MEF encoding quantum gate Appendix C), is applied to the target register when the control register state is |xₖ [symbol] _{ctrl}. This yields the state given by Equation (12). The final step involves decoding the period r of the MEF, achieved through the application of the phase operation \hat{P}ₖ=diag[1, e^{2πiφ}^{ₖ}, . . . , e^{2πi(d-1)φ}^{ₖ}] followed by the d-level inverse-QFT

$${\hat{F}}_{d}^{†} = \frac{1}{\sqrt{d}} {Σ}_{z = 0}^{d - 1} {e}^{- 2 π {ix}_{x} {z}_{x} / d} \vert {z}_{k} 〉 〈 {x}_{k} \vert ,$$

to the control register. This operation is represented as Equation (13)

$$\frac{1}{\sqrt{d}} {\sum }_{x = 0}^{d - 1} \vert x {〉}_{ctrl} \vert {ψ}_{k} {〉}_{tar} \qquad ( 11 )$$

$$\frac{1}{\sqrt{d}} {\sum }_{x = 0}^{d - 1} \vert x {〉}_{ctrl} ( {\hat{U}}_{a}^{{d}^{h - k} {x}_{k}} \vert {ψ}_{k} {〉}_{tar} ) \qquad ( 12 )$$

$$\frac{1}{d} {\sum }_{{z}_{k} = 0}^{d - 1} {\sum }_{{x}_{k} = 0}^{d - 1} {e}^{2 π {ix}_{k} ( {ϕ}_{k} - {z}_{k} / d )} \vert {z}_{k} {〉}_{ctrl} ( {\hat{U}}_{a}^{{d}^{h - k} {x}_{k}} \vert {ψ}_{k} {〉}_{tar} ) \qquad ( 13 )$$

The control register is then measured in the computational basis to obtain an outcome vₖ which is the k^{th} digit of precision. The measurement outcomes from a number/recycling steps are employed to set the phase

$${ϕ}_{k + 1} = - {Σ}_{l = 1}^{k} {v}_{l} / {d}^{k - l + 2}$$

of the phase operator \hat{P}ₖ₊₁=diag[1, e^{2πiφ}^{ₖ₊₁}, . . . , e^{2πi(d-1)φ}^{ₖ₊₁}] of the subsequent recycling step as outlined in FIG. 3.

The recycling process continues until reaching the h^{th} step, targeting a precision of ┌2 log_{d} N┐ units, essential for the accurate factorization of N. As the process advances to the k^{th} recycling step, the target register state becomes

$${\vert {ψ}_{k} {〉}_{tar} = \frac{1}{d} {\sum }_{{x}_{k} = 0}^{d - 1} {e}^{2 π {ix}_{k} ( {ϕ}_{k} - {z}_{k} / d )} \vert {ψ}_{k - 1} {a}^{{d}^{h - k + 1} {x}_{k}} mod N 〉}_{tar} ,$$

where this state is obtained at the end of the (k−1)^{th} recycling step. The computational outcomes are produced by a base-d number

$$M = {\sum }_{k = 1}^{h} {d}^{k - 1} {v}_{k} ,$$

achieving an h-qudit precision. The period r is determined by implementing a continued fraction expansion algorithm on M. Subsequently, the greatest common divisor equation gcd(a^{r/2}±1, N) is used to identify potential prime factors of N.

The optimal period-finding condition of the continued fraction expansion algorithm is dictated by N₂<d^{h}<2N, where d^{h} is the dimensionality of the control register after h recycling steps. For the case of N=15 factorization using qubits (d=2), eight recycling steps are required (since 15²<2⁸<2×15²). In contrast, using 16-level qudits, the same condition is met with only two recycling steps, as 15²<16²<2×15². Accordingly, exploiting 16-level qudits requires four times fewer iterations and is consequently four times faster than the qubit-recycling approach, while providing the same optimal precision.

$${\hat{U}}_{a}^{x}$$

In the original Shor's algorithm, the MEF is encoded by applying the operator to the target register whereas within iterative approach, this encoding process is broken down by dividing the operator

$${\hat{U}}_{a}^{x}$$

into h steps, leveraging the fact that the exponent x can be expressed in base d as a sum of digits as given by Equation (14).

$$\begin{matrix}{\hat{U}}_{a}^{x} & = {\hat{U}}_{a}^{{d}^{h - 1} {x}_{1} + {d}^{h - 2} {x}_{2} + ⋯ {d}^{0} {x}_{h}} \\ & = {\hat{U}}_{a}^{{d}^{h - 1} {x}_{1}} {\hat{U}}_{a}^{{d}^{h - 2} {x}_{2}} … {\hat{U}}_{a}^{{d}^{0} {x}_{h}}\end{matrix} \qquad ( 14 )$$

In each recycling step, the operator

$${\hat{U}}_{a}^{{d}^{h - k} {x}_{k}}$$

is applied to the target register sequentially (as shown in FIG. 1), with k representing the recycling step. The structure

$${\hat{U}}_{a}^{{d}^{h - k} {x}_{k}}$$

is driven a priori by the classical values

$${a}^{{d}^{h - k} {x}_{k}}$$

mod N, which vary depending on the level d of units used in the algorithm. For example, when factoring the number N=15 using 16-level units, two recycling steps are required. The quantum gates are represented as the identity

$$( {\hat{U}}_{a}^{16 {x}_{1}} : \vert 1 {〉}_{tar} ↦ \vert 1 {〉}_{tar} )$$

for the first step, and

$${\hat{U}}_{a}^{{x}_{2}} : \vert 1 {〉}_{tar} ↦ \vert {a}^{{x}_{2}} mod 15 {〉}_{tar}$$

for the second step. To implement this, the inventors sequentially assign the output ports of the ProAP-Fil to states |0 [symbol] ₜₐᵣ to |15 [symbol] ₜₐᵣ and program the ProAP-Fil to conditionally map the initial time qudit state |1 [symbol] ₜₐᵣ to the corresponding target register state

$$\vert {a}^{1 {6}^{h - k} {x}_{k}} mod N {〉}_{tar}$$

This mapping can be performed for all random integers a through the ProAP-Fil and can be universally applied to factor larger numbers.

### MEF Circuit Performance

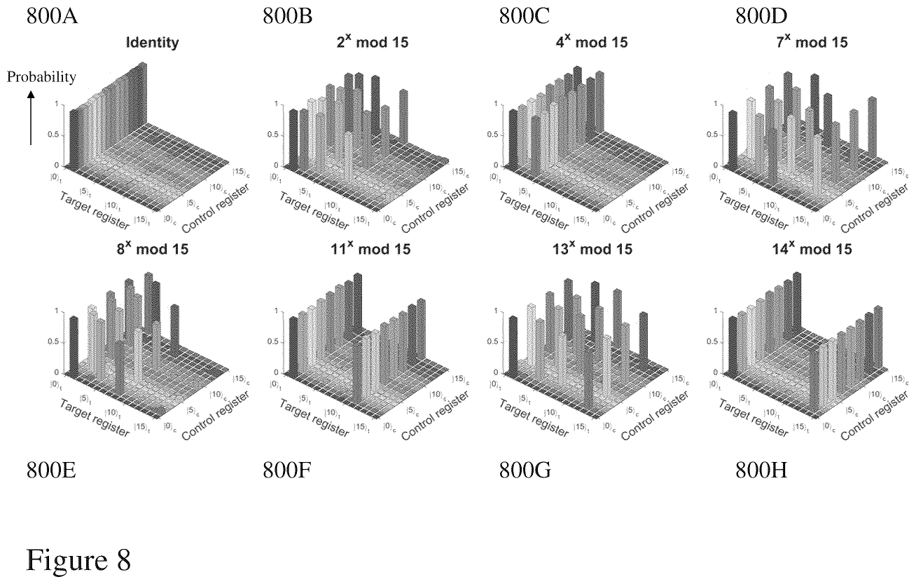

The inventors verified the performance of the MEF circuit at each recycling step by measuring the probability of obtaining the expected state |xₖ [symbol] _{ctrl}|p [symbol] ₜₐᵣ (p=0, 1, . . . , 15), given the input state |xₖ [symbol] _{ctrl}|₁ [symbol] ₜₐᵣ. FIG. 8 depicts the probability distribution of the control and target registers for N=15 factorization. At the 1^{st} (k=1) recycling step, where

$$\vert {x}_{1} {〉}_{ctrl} {\hat{U}}_{a}^{16 {x}_{1}} \vert 1 {〉}_{tar} = \vert {x}_{1} {〉}_{ctrl} \vert 1 {〉}_{tar}$$

for all possible random integers a, the average probability of returning the state |1 [symbol] ₜₐᵣ is 0.936. At the final (k=2) recycling step, the average probabilities of achieving the unitary transformation

$$\vert {x}_{2} {〉}_{ctrl} {\hat{U}}_{a}^{{x}_{2}} \vert 1 {〉}_{tar} = \vert {x}_{2} {〉}_{ctrl} \vert {a}^{{x}_{2}} mod 15 {〉}_{tar}$$

are 0.903, 0.937, 0.917, 0.906, 0.938, 0.922, and 0.943 for a=2, 4, 7, 8, 11, 13, and 14, respectively.

Within FIG. 8 first Image 800A depicts the probability output distribution corresponding to the identity operation

$$\vert {x}_{1} {〉}_{ctrl} {\hat{U}}_{a}^{16 {x}_{1}} \vert 1 {〉}_{tar} = \vert {x}_{1} {〉}_{ctrl} \vert 1 {〉}_{tar}$$

at the 1^{st} recycling step for all possible random integers a. Second to eighth Images 800B to 800H depict the probability output distributions corresponding to

$$\vert {x}_{2} {〉}_{ctrl} {\hat{U}}_{a}^{{x}_{2}} \vert 1 {〉}_{tar} = \vert {x}_{2} {〉}_{ctrl} \vert {a}^{{x}_{2}} mod 15 {〉}_{tar}$$

at the 2^{nd} recycling step for a=2, 4, 7, 8, 11, 13, and 14, respectively.

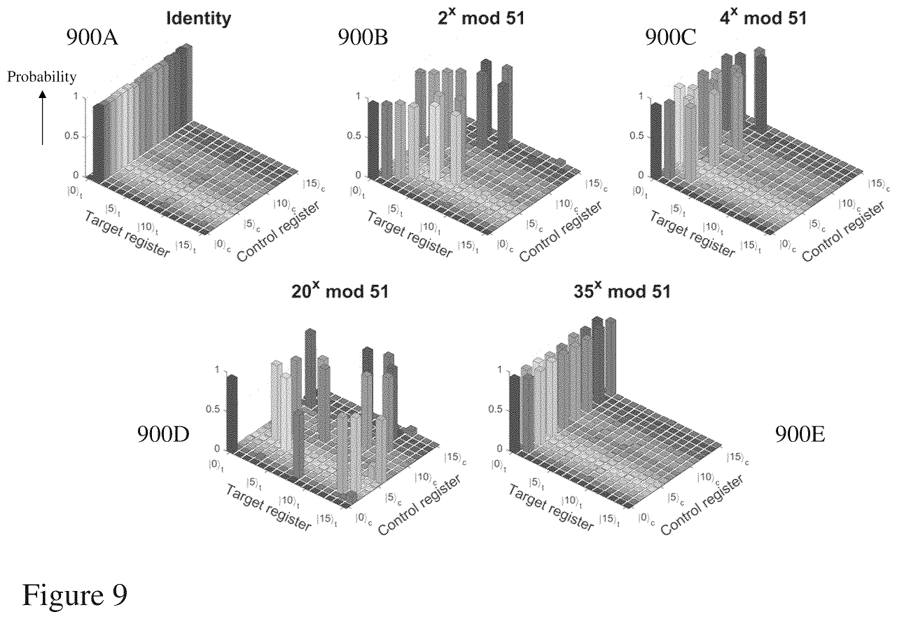

FIG. 9 depicts the probability distribution of the quantum registers for N=51 factorization. At the 1^{st} (k=1) and 2^{nd} (k=2) recycling steps,

$$\vert {x}_{k} {〉}_{ctrl} {\hat{U}}_{a}^{1 {6}^{3 - k} {x}_{k}} \vert 1 {〉}_{tar} = \vert {x}_{k} {〉}_{ctrl} \vert 1 {〉}_{tar}$$

(identity operation) for the random integers a considered, the average probability of returning the state |1 [symbol] ₜₐᵣ is 0.936. At the final (k=3) recycling step, the average probabilities of achieving the unitary transformation

$$\vert {x}_{3} {〉}_{ctrl} {\hat{U}}_{a}^{{x}_{3}} \vert 1 {〉}_{tar} = \vert {x}_{3} {〉}_{ctrl} \vert {a}^{{x}_{3}} mod 51 {〉}_{tar}$$

are 0.920, 0.935, 0.913, and 0.936 for a=2, 4, 20, and 35, respectively.

Within FIG. 9 first Image 900A depicts the probability output distribution corresponding to the identity operation at the 1^{st} (k=1), 2^{nd} (k=2) recycling steps for the random integers a considered. Second to fifth Images 900B to 900E respectively depict the probability output distributions corresponding to

$$\vert {x}_{3} {〉}_{ctrl} {\hat{U}}_{a}^{{x}_{3}} \vert 1 {〉}_{tar} = \vert {x}_{3} {〉}_{ctrl} \vert {a}^{{x}_{3}} mod 51 {〉}_{tar}$$

at the 3^{rd} recycling step for a=2, 4, 20, and 35, respectively. For the 3^{rd} recycling step, as outlined in this specification the inventors map the states |a^{x}^{₃} mod 51 [symbol] ₜₐᵣ to the output of the ProAP-Fil in ascending order.

### Random Integer Selection for N=51 Factorization

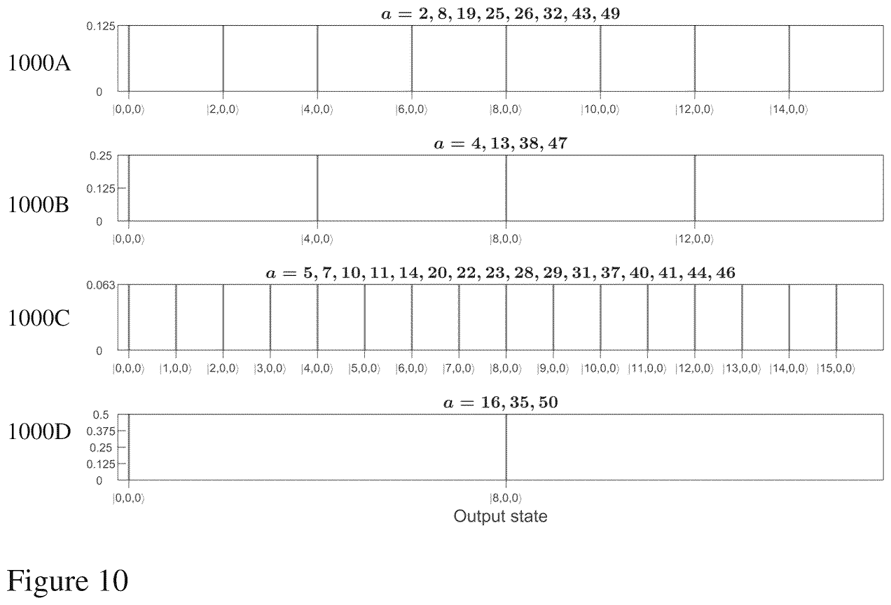

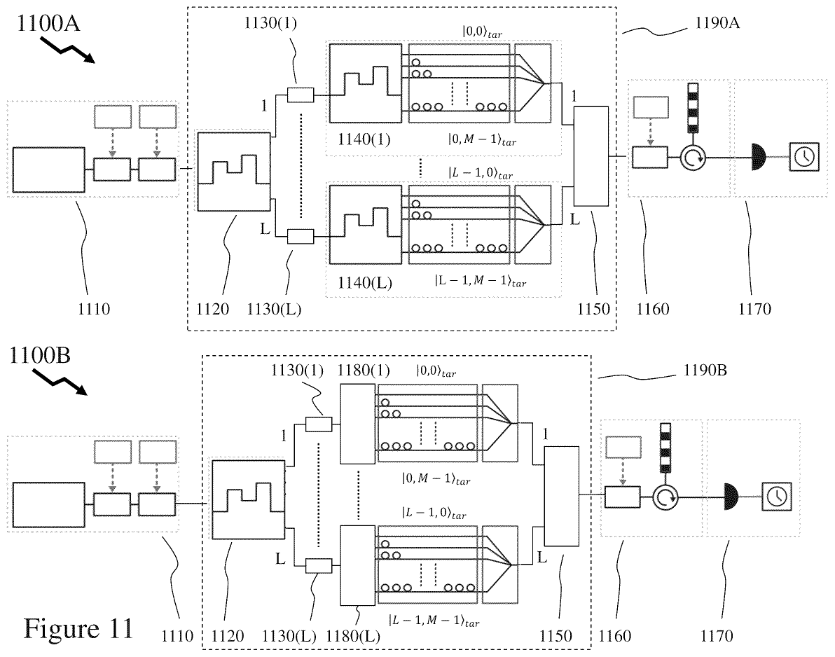

The inventors simulated the factorization of N=51 to determine the periods for all possible random integers, based upon considering recycling a 16-level qudit three times. The simulated results for a=2, 4, 5, 7, 8, 10, 11, 13, 14, 16, 19, 20, 22, 23, 25, 26, 28, 29, 31, 32, 35, 37, 38, 40, 41, 43, 44, 46, 47, 49, and 50, are shown in FIG. 10. Using the continued fraction expansion algorithm, we estimate the period r=2 for a=16, 35, 50 as depicted in fourth Image 1000D, r=4 for a=4, 13, 38, 47 as depicted in second Image 1000B; r=8 for a=2, 8, 19, 25, 26, 32, 43, 49 as depicted in first Image 1000A; and r=16 for a=5, 7, 10, 11, 14, 20, 22, 23, 28, 29, 31, 37, 40, 41, 44, 46 as depicted in third Image 1000C, respectively. For the experimental demonstration the inventors selected only a representative random integer for each period, i.e., a=2, 4, 20, 35 corresponding to periods r=8, 4, 16, and 2, respectively.

### SUMMARY

Accordingly, the inventors have presented an innovative photonic architecture which supports a qudit-state engineering to provide for an efficient Shor's algorithm implementation, The innovative photonic architecture establishes 16-level qudits, encoded in both the frequency and time DoFs within a single photon, as opposed to prior art qudit-based approaches. The innovative photonic architecture significantly reduces the number of quantum units and recycling steps required for factorization, addressing a major bottleneck in traditional implementations of Shor's algorithm.

As outlined above the innovative photonic architecture provides for a reduction in the recycling steps and computational time by employing 16-dimensional frequency and time qudits for the control and target registers. Further, the architecture is expandable to higher dimensional frequency and time qudits such that factorization of larger integers can be performed with a substantial reduction in the number of recycling steps needed which thereby directly translates into faster computation.

A major challenge in prior art approaches has been the probabilistic nature of entangling gates and the complexity of MEF encoding process. In contrast, the innovative photonic architecture overcomes these issues by utilizing a deterministic MEF encoding process, achieved via a programmable amplitude and phase shift element and by using separate DoFs for the control and target registers. This enables deterministic two-qudit gate operations, significantly reducing circuit depth.

Unlike prior experimental quantum computing platforms that are limited in scalability due to limited coherence times or complex circuit requirements the innovative photonic architecture outlined within this specification according to embodiments of the invention allows the invention to be highly scalable. Further, the innovative photonic architecture supports the use of telecommunications band CW lasers as well as fiber optic or guided wave photonic infrastructure including programmable amplitude and phase shifters, phase modulators, amplitude modulators, wavelength filters and optical circulators thereby ensuring compatibility with existing and evolving photonic technologies for lower cost, increased scalability and roadmap to monolithic integration. This versatility ensures that the methodologies outlined within this description for embodiments of the invention can be applied across different technologies, potentially improving their computational performance and efficiency in quantum algorithms.

The innovative photonic architecture according to embodiments of the invention also supports enhanced precision for the factorization outcomes when employed in implementing Shor's algorithm by fully meeting the computational requirements of the algorithm registers. By employing higher-dimensional qudits (i.e., 16-dimensional qudits vs 4-dimensional qudits as employed in the prior art) and optimizing the MEF encoding and recycling steps, the innovative photonic architecture provides for quantum processing that achieves a higher precision than previous Shor's algorithm implementations. The combination of fewer recycling steps, lower circuit depth, and deterministic operations leads to a highly resource-efficient approach to Shor's algorithm.

Whilst the description has focused to the innovative photonic architecture according to embodiments of the invention the architecture and underlying concepts can be applied to support programmability of other algorithms such as those that utilize inverse QFTs and deterministic qudit manipulations, such as the Deutsch-Jozsa algorithm and the Bernstein-Vazirani algorithm for example. Further, the ability to implement the Deutsch-Jozsa algorithm also supports the innovative photonic architecture according to embodiments of the invention being employed in executing quantum key distribution (QKD) protocols for secure quantum communications.

It would be evident to one of skill in the art that the architecture of the innovative photonic architecture according to the embodiment of the invention depicted in FIG. 5 can be extended to provide for higher-order qudits than the 16-level qudits supported by the embodiment depicted in FIG. 5. Whilst the 16-level qudits established in Schematic 500 in FIG. 5 may be employed to factor other integers as outlined above, although only the number 15 can be factored optimally by Schematic 500, other numbers can be factored in a compiled way where the tradeoff is that the number of recycling steps increases thereby increasing processing time. Extending the architecture to even higher order qudits would thereby allow for a reduction in the number of processing steps relative to those of using a lower order qudit. Such schemes may require either a number of ProAP-Fils or a single higher-port count ProAP-Fil such that whilst the scheme remains the same there should also be a scale-up in the processing ports if the algorithm is to be performed in a single step. Referring to FIG. 11 there are depicted first and second Architectures 1100A and 1100B respectively of embodiments of the invention which may be employed for generating higher order qudits.

Referring initially to first Architecture 1100A in FIG. 11 a State Preparation System 1110, employing a CW laser in conjunction with amplitude and phase modulators such as described above with respect to State Preparation 510 in FIG. 5 for example, is coupled to a MEF Encoding and Phase System 1190A and therein to an Inverse-QFT System 1160, which may be configured in a similar manner as Inverse-QFT 530 in FIG. 5 for example, and Measurement System 1170, which may be configured in a similar manner to Measurement 540 in FIG. 5 for example.

The MEF Encoding and Phase System 1190A comprises a 1×L ProAP-Fil 1120 which is coupled to L distinct Time Delays 1130(1) to 1130(L). Each of the L Time Delays 1130(1) to 1130(L) is coupled to L ProAP-Fils (each featuring 1×M port configurations), as shown in the MEF Encoding and Phase Modules 1140(1) to 1140(L) respectively. Each of the L ProAP-Fils are connected to a M×1 Combiner (such as represented by Component 523 in FIG. 5) within each of the MEF Encoding and Phase Modules 1140(1) to 1140(L) respectively after the time delays. This provides a total of L outputs, which are then coupled into an L×1 Combiner 1150 and therein to the Inverse-QFT System 1160 and Measurement System 1170. Each of the L MEF Encoding and Phase Modules 1140(1) to 1140(L) are configured according to the operation for

$${\hat{U}}_{a}^{{d}^{h - k} {x}_{k}} ,$$

for example, the MEF Encoding and Phase Operation 520 in FIG. 5. Accordingly, each of the L MEF Encoding and Phase Modules 1140(1) to 1140(L) respectively handles M time bins, as discussed with respect to the operation of Schematic 500. The L Time Delays 1130(1) to 1130(L) generate discrete time offsets for each of the L MEF Encoding and Phase Modules 1140(1) to 1140(L) respectively. This allows the first Architecture 1100A to establish an R-level time-bin qudit where R=L×M, with time bins |(0,0) [symbol] ₜₐᵣ, . . . , |(L−1, M−1) [symbol] ₜₐᵣ. The L Time Delays 1130(1) to 1130(L) being, for example, 0, M·t, 2·M·t, (L−1)·M·t.

Whilst the embodiment of the invention depicted in Architecture 1100A has L identical MEF Encoding and Phase Modules it would be evident in other embodiments of the invention that not all MEF Encoding and Phase Modules are identical to support other values of R for the R-level time-bin qudit.

Now referring to second Architecture 1100B in FIG. 11 a State Preparation System 1110, employing a CW laser in conjunction with amplitude and phase modulators such as described above with respect to State Preparation 510, is coupled to a MEF Encoding and Phase System 1190B and therein to an Inverse-QFT System 1160, which may be configured in a similar manner as Inverse-QFT 530 in FIG. 5 for example, and Measurement System 1170, which may be configured in a similar manner to Measurement 540 in FIG. 5 for example.

The MEF Encoding and Phase System 1190B comprises a 1×L ProAP-Fil 1120 where the outputs are each coupled to L distinct Time Delays 1130(1) to 1130(L). The outputs of each of the L Time Delays 1130(1) to 1130(L) are coupled to a defined 1×M Switch 1180(1) to 1180(L). The outputs of each 1×M Switch 1180(1) to 1180(L) are coupled to M Time Delays and therein a M ×1 Combiner, which is configured as per MEF Encoding and Phase Operation 520 for example, and therein via L×1 Combiner 1150 to a single output. The output of the MEF Encoding and Phase Module 1190B being coupled to the Inverse-QFT System 1160 and Measurement System 1170. Accordingly, the MEF Encoding and Phase Module 1190B handles L x M time bins and establishes an R-level time-bin qudit where R=L X M, similar to MEF Encoding and Phase Module 1190A, such that the second Architecture 1100B can establish a target register qudit of order R where R=L×M, with time bins |(0,0) [symbol] ₜₐᵣ, . . . , |(L−1, M−1) [symbol] ₜₐᵣ. The L Time Delays 1130(1) to 1130(L) being, for example, 0, M·t, 2·M·t, (L−1)·M·t.

In second Architecture 1100B a single ProAP-Fil 1120 is employed and re-configured for each sequential time delay offset of the L Time Delays 1130(1) to 1130(L) such that circuit complexity is reduced relative to first Architecture 1100A. Within other embodiments of the invention a switchable optical delay line may be employed with the programmable amplitude and phase filter, ProAP-Fil. Phase feedback as discussed above in respect of FIG. 5 is now implemented via the 1×L ProAP-Fil 1120.

It would be evident that accordingly the innovative photonic architecture can be employed to establish d-ary qudits with higher d than 16 such that an architect of a quantum processor can balance the circuit complexity to determine the dimension d of the qudit and the number of recycling steps the quantum processor employs whilst supporting deterministic MEF encoding processes and fulfilling the computational demands for larger number Shor's algorithm factorization and execution of other quantum algorithms.

The innovative photonic architecture according to embodiments of the invention can be implemented using monolithic and/or hybrid integration of photonic elements. The material system/systems exploited may be selected in dependence upon the functionality required and the optical performance, e.g. loss, crosstalk and modulation speed. For example, monolithic integration may exploit InGaAsP photonic circuit elements to provide the CW laser, amplitude modulator, phase modulators, programmable amplitude and phase filter, combiner, FBG (or equivalent filter) with integrated optical delay lines or with external fiber-optic/waveguide delay lines. Hybrid integration may exploit a PIC with CW laser, amplitude modulator and phase modulators in InGaAsP with a silica-on-insulator circuit providing the programmable amplitude and phase filter, combiner, FBG and optical delay lines.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
encoding a first d-level qudit with a first register associated with a quantum algorithm within a first degree of freedom of a photon;
encoding a second d-level qudit with a second register associated with the quantum algorithm within a second degree of freedom of the photon; and
executing a quantum algorithm which is executed in a two or more step process and employs a deterministic two-d-level qudit entangling gate operation with the first d-level qudit and second d-level qudit where the second d-level qudit is recycled between sequential steps of the process.

2. The method according to claim 1, wherein
the single photon is generated from a continuous wave (CW) optical source;
the first degree of freedom of the photon is time and the first d-level qudit is encoded onto the single photon by an amplitude modulator;
the second degree of freedom is frequency and the second d-level qudit is encoded onto the single photon by a phase modulator; and
the quantum algorithm employs a modular exponentiation factor.

3. The method according to claim 2, wherein
the quantum algorithm employs a modular exponentiation factor (MEF) encoding circuit which processes the single photon onto which the first d-level qudit and second d-level qudit have been encoded; and
a period of the MEF is established by applying a phase operation to an output of the MEF with a phase encoding circuit and then applying an inverse-quantum Fourier transform to output of the phase encoding circuit.

4. The method according to claim 3, wherein
the first degree of freedom of the photon is time where the first d-level qudit is encoded onto the single photon by an amplitude modulator;
the second degree of freedom is frequency where the second d-level qudit is encoded onto the single photon by a phase modulator; and
the MEF encoding circuit comprises:
a programmable amplitude and phase filter circuit which generating d-outputs from an input comprising the dual d-level encoded qudit where each output is a frequency component of the dual d-level encoded qudit;
an optical time delay block comprising d paths where each path has a defined time delay; and
an optical combiner combining the d paths from the optical time delay block such that the frequency components of the dual d-level encoded qudit are time multiplexed.

5. The method according to claim 4, wherein
a value of d for the first d-level qudit and the second d-level qudit is 16; and
the quantum algorithm executes Shor's algorithm in two process steps to factor an integer N; and
N ≥15.

6. The method according to claim 5, wherein
the quantum algorithm employs a modular exponentiation factor (MEF) encoding circuit which processes the single photon onto which the first d-level qudit and second d-level qudit have been encoded;
a period of the MEF is established by applying a phase operation to an output of the MEF with a phase encoding circuit and then applying an inverse-quantum Fourier transform (IQFT) to an output of the phase encoding circuit with an IQFT circuit; and
an output of the IQFT is processed by a measurement circuit and a result from the measurement circuit is fed to the MEF encoding circuit after each process step of the two or more step process to establish a phase parameter of the MEF encoding circuit for the next process step.

7. The method according to claim 6, wherein
the MEF encoding circuit comprises:
a programmable amplitude and phase filter circuit which generating d-outputs from an input comprising the dual d-level encoded qudit where each output is a frequency component of the dual d-level encoded qudit;
an optical time delay block comprising d paths where each path has a defined time delay; and
an optical combiner combining the d paths from the optical time delay block such that the frequency components of the dual d-level encoded qudit are time multiplexed; and
the phase parameter established for the MEF is applied to the programmable amplitude and phase filter circuit in a next subsequent step of the sequential steps of the process.

8. The method according to claim 3, wherein
the first degree of freedom of the photon is time where the first d-level qudit is encoded onto the single photon by an amplitude modulator;
the second degree of freedom is frequency where the second d-level qudit is encoded onto the single photon by a phase modulator; and
the MEF encoding circuit comprises:
a programmable amplitude and phase filter generating L outputs where each output of the L outputs is coupled to a defined circuit of L circuits via a defined time delay;
the L circuits; and
a L×1 optical combiner coupled to each output of each circuit of the L circuits; and
each circuit comprises:
a programmable amplitude and phase filter circuit which generating M-outputs from an input comprising the dual d-level encoded qudit where each output is a frequency component of the dual d-level encoded qudit;
an optical time delay block comprising M paths where each path has a defined time delay; and
a M×1 optical combiner combining the M paths from the optical time delay block such that the frequency components of the dual d-level encoded qudit are time multiplexed.

9. The method according to claim 3, wherein
the first degree of freedom of the photon is time where the first d-level qudit is encoded onto the single photon by an amplitude modulator;
the second degree of freedom is frequency where the second d-level qudit is encoded onto the single photon by a phase modulator; and
the MEF encoding circuit comprises:
a programmable amplitude and phase filter which generating L-outputs from an input comprising the dual d-level encoded qudit where each output is a frequency component of the dual d-level encoded qudit;
an optical time delay block comprising L paths where each path has a defined time delay; and
a switch comprising an input and M outputs where each output of the M outputs is coupled to a defined time delay and combined using a M×1 optical combiner; and
a L×1 optical combiner combining the L paths from the optical time delay block such that the frequency components of the dual d-level encoded qudit are time multiplexed; and
the controlled phase operations are implemented by the programmable amplitude and phase filter within the MEF encoding circuit.

10. A method comprising:
applying simultaneous qudit encoding in both frequency and time domains of freedom of a single photon; and
executing a quantum algorithm with the simultaneously encoded single photon which includes a deterministic two-qudit entangling gate operation.

11. A photonic quantum computing system, wherein
the photonic quantum computing system applies simultaneous qudit encoding in both frequency and time domains of freedom to a single photon.

12. A photonic quantum computing system, wherein
the photonic quantum computing system applies simultaneous qudit encoding in both frequency and time domains of freedom to a single photon; and
the photonic quantum computing system executes a quantum algorithm comprising at least a deterministic two-qudit entangling gate operation performed with the simultaneously encoded single photon.
